(19) United States
(12) Patent Application Publication
(10) Pub. No.: US 2025/0023265 A1
(43) Pub. Date: Jan. 16, 2025

(54) MATING CONNECTOR AND ELECTRICAL CONNECTOR ASSEMBLY WITH LOW MATING HEIGHT

(71) Applicant: DONGGUAN LUXSHARE TECHNOLOGIES CO., LTD, Dongguan City (CN)

(72) Inventors: Hengshan CHENG, Dongguan City (CN); Tao SONG, Dongguan City (CN); Hongji CHEN, Dongguan City (CN)

(73) Assignee: DONGGUAN LUXSHARE TECHNOLOGIES CO., LTD, Dongguan City (CN)

(21) Appl. No.: 18/897,750

(22) Filed: Sep. 26, 2024

Related U.S. Application Data
(63) Continuation-in-part of application No. 17/834,523, filed on Jun. 7, 2022.
(63) Continuation-in-part of application No. 17/839,873, filed on Jun. 14, 2022.
(63) Continuation-in-part of application No. 17/958,829, filed on Oct. 3, 2022.

(30) Foreign Application Priority Data
Jun. 16, 2021 (CN) 202110665729.0
Jun. 16, 2021 (CN) 202121340213.0
Oct. 12, 2021 (CN) 202122460467.2
Aug. 29, 2024 (CN) 202411205106.5

(51) Int. Cl. H01R 12/71; H01R 13/627; H01R 13/629

(52) U.S. Cl. CPC H01R 12/716; H01R 13/627; H01R 13/629

(57) ABSTRACT

A mating connector includes a mating insulating body and a number of mating terminals. The mating connector is configured to be installed on a first circuit board in a first position for mating with a first electrical connector. The first electrical connector includes a first cable. The mating connector is also configured to be installed on a second circuit board in a second position for mating with a second electrical connector. The second electrical connector includes a second cable. The mating connector in the second position is formed by rotating the mating connector in the first position by 180 degrees in a plane where the first circuit board is located. Neither the first cable nor the second cable is folded, and outlet directions of the first cable and the second cable are the same. An electrical connector assembly including the mating connector is also disclosed.

### CROSS-REFERENCE TO RELATED APPLICATIONS

This patent application claims priority of a Chinese Patent Application No. 202411205106.5, filed on Aug. 29, 2024 and titled “MATING CONNECTOR AND ELECTRICAL CONNECTOR ASSEMBLY”, and is a continuation-in-part of U.S. patent application Ser. No. 17/834,523, filed on Jun. 7, 2022 and titled “STRAP CONNECTOR AND ASSEMBLY THEREOF WITH ENHANCED MATING RETENTION FORCE”, which claims priority of a Chinese Patent Application No. 202110665729.0, filed on Jun. 16, 2021, a continuation-in-part of U.S. patent application Ser. No. 17/839,873, filed on Jun. 14, 2022 and titled “CONNECTOR AND ASSEMBLY THEREOF WITH FOOLPROOF STRUCTURE”, which claims priority of a Chinese Patent Application No. 202121340213.0, filed on Jun. 16, 2021, and a continuation-in-part of U.S. patent application Ser. No. 17/958,829, filed on Oct. 3, 2022 and titled “PULL STRAP CONNECTOR AND ASSEMBLY THEREOF WITH IMPROVED LOCKING FEATURES”, which claims a priority of a Chinese Patent Application No. 202122460467.2, filed on Oct. 12, 2021, the entire content of which is incorporated herein by reference.

### TECHNICAL FIELD

The present disclosure relates to a mating connector and an electrical connector assembly, which belong to the technical field of connectors.

### BACKGROUND

As shown in FIG. 1 and FIG. 2, an electrical connector assembly in the related art usually includes a first circuit board 300″, a mating connector 200″ installed on the first circuit board 300″ and a first electrical connector 100″ for being inserted into the mating connector 200″. The mating connector 200″ defines a mating slot 8120″. The first electrical connector 100″ includes a first tongue plate 12″, a first positioning plate 13″ protruding beyond the first tongue plate 12″ and a plurality of first cables 5″. The first positioning plate 13″ is configured to be inserted into the positioning groove of the mating connector 200″ at a fixed angle. Referring to FIG. 1, when the mating connector 200″ is inserted into the first electrical connector 100″, its state is as shown in an electrical connector assembly on a left side of FIG. 1.

As installation requirements continue to increase, the mating connector 200″ on the left side in FIG. 1 needs to be rotated by 180 degrees in some cases and then installed on a second circuit board 300′ “. In other words, the structure of the mating connector 200” itself has not changed, but the installation angle has been rotated by 180 degrees. It is understandable to those skilled in the art that at this time, correspondingly, an outlet direction of the first cables 5″ of the first electrical connector 100″ that is inserted in the mating connector 200″ on the right side in FIG. 1 is bound to have an opposite outlet direction of the first cables 5″ of the first electrical connector 100″ that is inserted into the mating connector 200″ on the left side. In order to arrange the first cables 5″ of the two first electrical connectors 100″ together as much as possible, as shown in FIG. 1, it is proposed in the related art that to reversely fold the first cables 5″ of the first electrical connector 100″ on the right side, so that the first cables 5″ of the two first electrical connectors 100″ are made as close as possible.

However, due to the reverse folding of the first cables 5″, this results in a higher overall height of the electrical connector assembly, and the reverse folding can easily damage the first cables 5″.

Therefore, it is desirable to improve the mating connector and the electrical connector assembly in the related art.

### SUMMARY

An object of the present disclosure is to provide a mating connector and an electrical connector assembly with a low mating height.

In order to achieve the above object, the present disclosure adopts the following technical solution: a mating connector, including: a mating insulating body, the mating insulating body including a bottom wall, a plurality of wall portions and a mating slot at least partially formed by the plurality of wall portions; the bottom wall defining a positioning groove in communication with the mating slot; the plurality of wall portions including a first wall portion and a second wall portion which is disposed opposite to the first wall portion; the mating slot being located between the first wall portion and the second wall portion; and a plurality of mating terminals, the plurality of mating terminals being provided on the mating insulating body, each mating terminal including an elastic mating arm extending into the mating slot; wherein the mating connector is configured to be installed on a first circuit board in a first position to mate with a first electrical connector; the first electrical connector includes a first tongue plate, a plurality of first mating portions provided on the first tongue plate, a first positioning plate protruding beyond the first tongue plate, and a first cable; the mating slot and the positioning groove are configured to receive the first tongue plate and the first positioning plate of the first electrical connector, respectively; the first mating portion is in contact with the elastic mating arm; the mating connector is also configured to be mounted on a second circuit board in a second position to mate with a second electrical connector; the second electrical connector includes a second tongue plate, a plurality of second mating portions provided on the second tongue plate, a second positioning portion protruding beyond the second tongue plate, and a second cable; the mating slot and the positioning groove are configured to receive the second tongue plate and the second positioning plate of the second electrical connector, respectively; the second mating portion is in contact with the elastic mating arm; the first circuit board and the second circuit board are the same or different circuit boards; the first electrical connector and the second electrical connector are the same or different electrical connectors; the mating connector in the second position is formed by rotating the mating connector in the first position by 180 degrees in a plane where the first circuit board is located; neither the first cable nor the second cable is folded, and outlet directions of the first cable and the second cable are the same.

In order to achieve the above object, the present disclosure adopts the following technical solution: an electrical connector assembly, including: a mating connector, the mating connector including: a mating insulating body, the mating insulating body including a bottom wall, a plurality of wall portions and a mating slot at least partially formed by the plurality of wall portions; the bottom wall defining a positioning groove in communication with the mating slot; the plurality of wall portions including a first wall portion and a second wall portion opposite to the first wall portion; the mating slot being located between the first wall portion and the second wall portion; and a plurality of mating terminals, the plurality of mating terminals being provided on the mating insulating body; each mating terminal including an elastic mating arm extending into the mating slot; a first electrical connector, the first electrical connector including a first tongue plate, a plurality of first mating portions provided on the first tongue plate, a first positioning plate protruding beyond the first tongue plate, and a first cable; another mating connector, the another mating connector having a same structure as the mating connector, but having a different installation angle; and a second electrical connector, the second electrical connector including a second tongue plate, a plurality of second mating portions provided on the second tongue plate, a second positioning portion protruding beyond the second tongue plate, and a second cable; wherein the mating connector is configured to be installed on a first circuit board in a first position to mate with the first electrical connector; the mating slot and the positioning groove of the mating connector receive the first tongue plate and the first positioning plate of the first electrical connector, respectively; the first mating portion is in contact with the elastic mating arm of the mating connector; the another mating connector is configured to be mounted on a second circuit board in a second position to mate with the second electrical connector; the mating slot and the positioning groove of the another mating connector receive the second tongue plate and the second positioning slot of the second electrical connector, respectively; the second mating portion is in contact with the elastic mating arm of the another mating connector; the first circuit board and the second circuit board are the same or different circuit boards; the first electrical connector and the second electrical connector are the same or different electrical connectors; the another mating connector in the second position is formed by rotating the mating connector in the first position by 180 degrees in a plane where the first circuit board is located; neither the first cable nor the second cable is folded; and outlet directions of the first cable and the second cable are the same.

Compared with the prior art, the mating connector of the present disclosure is configured to be installed on the first circuit board in the first position to mate with the first electrical connector. The first electrical connector includes the first tongue plate, the first positioning plate protruding beyond the first tongue plate, and the first cable. The mating slot and the positioning groove are configured to receive the first tongue plate and the first positioning plate of the first electrical connector, respectively. The mating connector is also configured to be mounted on the second circuit board in the second position to mate with the second electrical connector. The second electrical connector includes the second tongue plate, the second positioning plate protruding beyond the second tongue plate, and the second cable. The mating slot and the positioning groove are configured to receive the second tongue plate and the second positioning plate of the second electrical connector, respectively. The mating connector in the second position is formed by rotating the mating connector in the first position by 180 degrees in the plane where the first circuit board is located. Neither the first cable nor the second cable is folded. The outlet directions of the first cable and the second cable are the same. The present disclosure further discloses the electrical connector assembly including the mating connector, the another mating connector, the first electrical connector and the second electrical connector. With this arrangement, the mating connector and the electrical connector assembly of the present disclosure avoid the problem of cable bending, thereby reducing the mating height.

### BRIEF DESCRIPTION OF DRAWINGS

FIG. 1 is a perspective schematic view of an electrical connector assembly in the related art, in which two mating connectors are rotated 180 degrees to each other and correspondingly installed on a first circuit board and a second circuit board, respectively, and are mating with corresponding first electrical connectors;

FIG. 2 is a partially exploded perspective view of FIG. 1, in which the two first electrical connectors are separated;

FIG. 3 is a perspective view of an electrical connector assembly in accordance with a first embodiment of the present disclosure, in which a first electrical connector is in mating with a mating connector, and the mating connector is mounted on a first circuit board in a first position;

FIG. 4 is a perspective view of FIG. 3 from another angle;

FIG. 5 is a rear view of FIG. 3;

FIG. 6 is a partially exploded perspective view of FIG. 3;

FIG. 7 is a partially exploded perspective view of FIG. 6 from another angle;

FIG. 8 is a right side view of a mating state of the mating connector excluding the first circuit board and the first electrical connector;

FIG. 9 is a right view of the mating connector excluding the first circuit board and the first electrical connector in a separated state;

FIG. 10 is a further perspective exploded view of the electrical connector assembly of the present disclosure;

FIG. 11 is a further perspective exploded view of the first electrical connector in FIG. 10;

FIG. 12 is a further perspective exploded view of the first electrical connector in FIG. 11;

FIG. 13 is a top view of the first electrical connector in FIG. 6;

FIG. 14 is a schematic cross-sectional view taken along line D-D in FIG. 8;

FIG. 15 is a further perspective exploded view of the mating connector in FIG. 10;

FIG. 16 is an exploded perspective view of a mating insulating body and mating terminals in FIG. 15;

FIG. 17 is an enlarged view of circled portion A in FIG. 4;

FIG. 18 is a partially exploded perspective view of the electrical connector assembly of the present disclosure, in which the mating connector in FIG. 6 is rotated by 180 degrees to be installed on a second circuit board in a second position and configured to mate with a second electrical connector;

FIG. 19 is a partially exploded perspective view of FIG. 18 from another angle;

FIG. 20 is a perspective view of the electrical connector assembly in accordance with a second embodiment of the present disclosure, in which the first electrical connector is in mating with a mating connector, and the mating connector is mounted on a first circuit board in a first position;

FIG. 21 is a perspective view of FIG. 20 from another angle;

FIG. 22 is a front view of FIG. 20;

FIG. 23 is a rear view of FIG. 20;

FIG. 24 is a right view of FIG. 20;

FIG. 25 is a left view of FIG. 20;

FIG. 26 is an exploded perspective view of the first electrical connector and the mating connector in FIG. 20;

FIG. 27 is an exploded perspective view of FIG. 26 from another angle;

FIG. 28 is a partial enlarged view of circled portion E in FIG. 26;

FIG. 29 is a partial enlarged view of circled portion F in FIG. 26;

FIG. 30 is a partial enlarged view of circled portion G in FIG. 27;

FIG. 31 is a partial enlarged view of circled portion H in FIG. 27;

FIG. 32 is a partially exploded perspective view of the first electrical connector shown in FIG. 26;

FIG. 33 is a partially exploded perspective view of FIG. 32 from another angle;

FIG. 34 is a partially exploded perspective view of the mating connector of FIG. 26;

FIG. 35 is a partially exploded perspective view of FIG. 34 from another angle;

FIG. 36 is a top view of the mating connector of FIG. 26;

FIG. 37 is a schematic cross-sectional view taken along line K1-K1 in FIG. 24, in which the first circuit board is not shown;

FIG. 38 is a schematic cross-sectional view taken along line K2-K2 in FIG. 24, in which the first circuit board is not shown;

FIG. 39 is a partially exploded perspective view of the electrical connector assembly of the present disclosure, in which the mating connector in FIG. 26 is rotated by 180 degrees to be installed on a second circuit board in a second position and configured to mate with a second electrical connector;

FIG. 40 is a partially exploded perspective view of FIG. 39 from another angle;

FIG. 41 is a left view of the mating connector in FIG. 27 installed on the first circuit board and configured to mate with the first electrical connector, and another mating connector installed on the second circuit board and configured to mate with the second electrical connector;

FIG. 42 is a partially exploded perspective view of the electrical connector assembly in accordance with a third embodiment of the preset disclosure, in which the mating connector is mounted on the first circuit board in the first position and is configured to mate with the first electrical connector, and the another mating connector is mounted on the second circuit board in the second position and is configured to mate with the second electrical connector;

FIG. 43 is a right view of FIG. 42;

FIG. 44 is a top view of FIG. 42, wherein the first electrical connector is offset from the mating connector, and the second electrical connector is offset from the another mating connector;

FIG. 45 is a partially exploded perspective view of the electrical connector assembly in accordance with the third embodiment of the present disclosure, in which the mating connector is separated from the first electrical connector, and the another mating connector is separated from the second electrical connector;

FIG. 46 is a perspective view of the first electrical connector and the second electrical connector in FIG. 45 from another angle;

FIG. 47 is a left view of the electrical connector assembly in accordance with a fourth embodiment of the present disclosure, in which the mating connector is mounted on the first circuit board in the first position and is configured to mate with the first electrical connector, and the another mating connector is mounted on the second circuit board in the second position and is configured to mate with the second electrical connector;

FIG. 48 is a top view of FIG. 47, wherein the first electrical connector is offset from the mating connector, and the second electrical connector is offset from the another mating connector; and

FIG. 49 is a partially exploded perspective view of the electrical connector assembly in accordance with the third embodiment of the present disclosure, in which the mating connector is separated from the first electrical connector, and the another mating connector is separated from the second electrical connector.

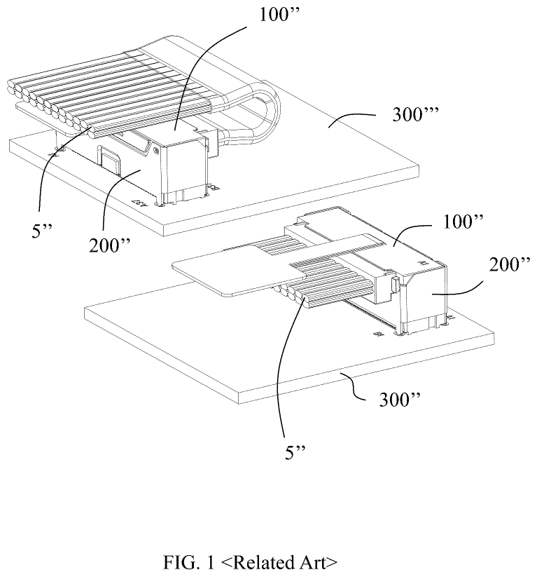

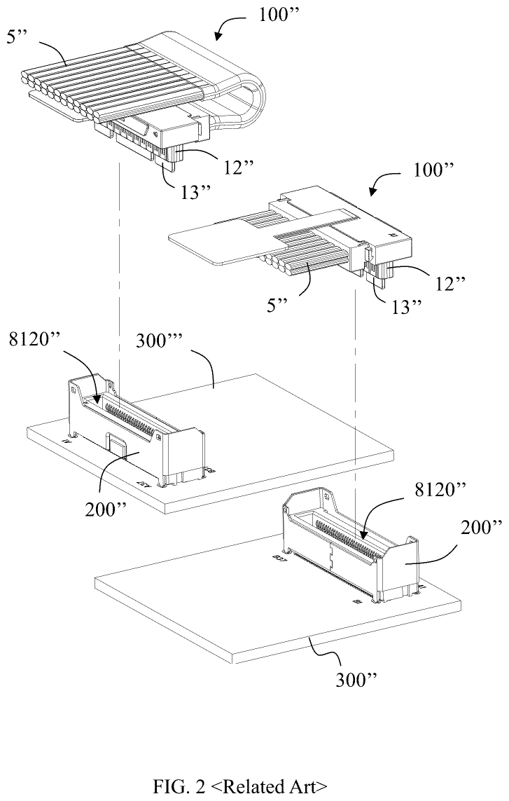

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

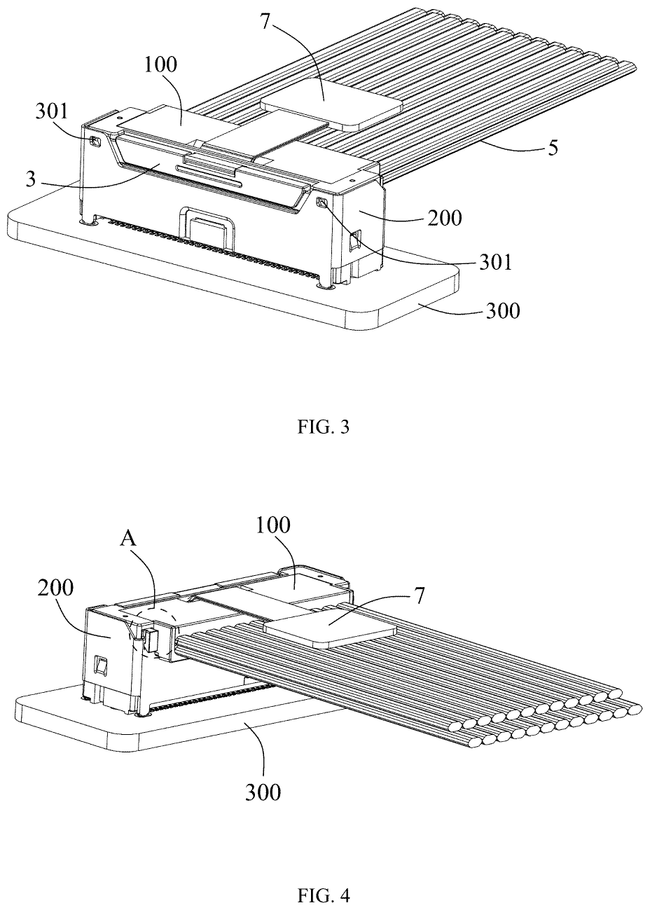

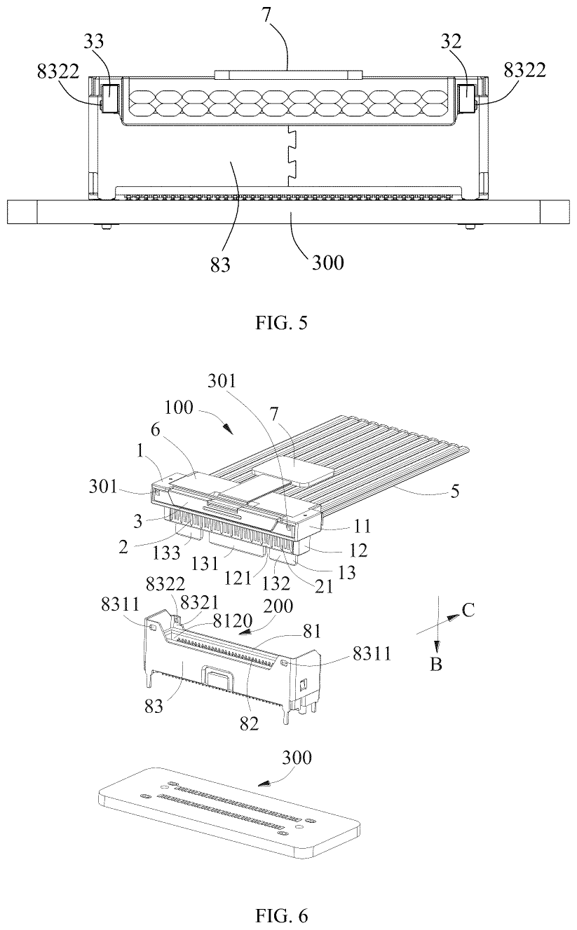

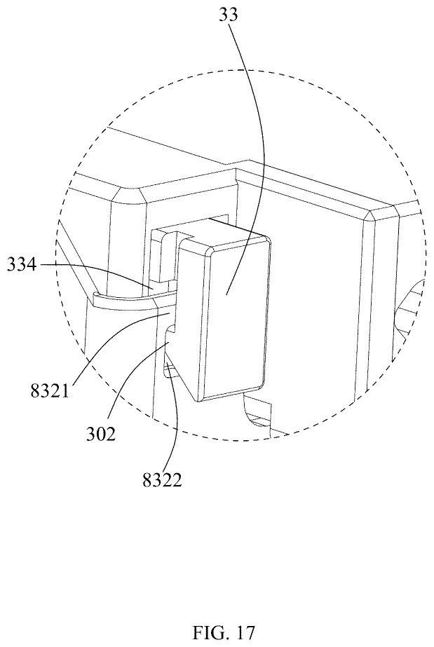

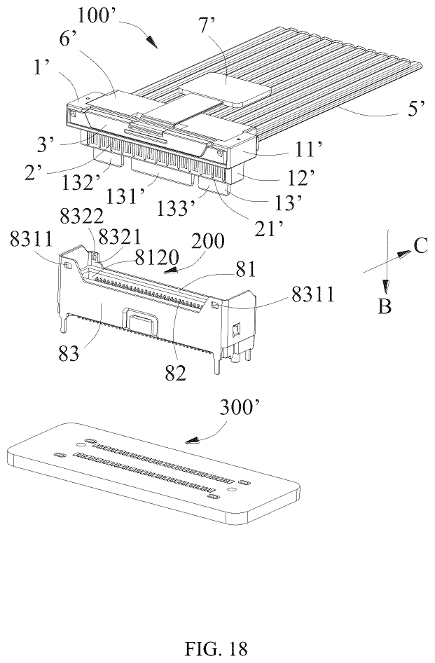

Referring to FIG. 3 to FIG. 19, in a first embodiment of the present disclosure, it discloses an electrical connector assembly, which includes a first electrical connector 100, a mating connector 200 for mating with the first electrical connector 100, a second electrical connector 100′, and another mating connector 200′ for mating with the second electrical connector 100′. In the illustrated embodiment of the present disclosure, the first electrical connector 100 and the second electrical connector 100′ are pull strap connectors and cable-end connectors. The mating connector 200 is a board-end connector configured to be installed on a first circuit board 300 in a first position. The another mating connector 200′ is a board-end connector configured to be installed on a second circuit board 300′ in a second position. Referring to FIG. 6, the first electrical connector 100 is configured to mate with the mating connector 200 along a mating direction B (for example, a top-to-bottom direction) to achieve data transmission. Referring to FIG. 18, the second electrical connector 100′ is configured to mate with the another mating connector 200′ along the mating direction B to achieve data transmission.

In the illustrated embodiment of the present disclosure, the mating connector 200 and the another mating connector 200′ are connectors with the same structure, except that their installation angles differ by 180 degrees. In other words, it can be understood that the another mating connector 200′ is formed by rotating the mating connector 200 by 180 degrees in a plane where the first circuit board 300 is located.

The first circuit board 300 and the second circuit board 300′ may be the same or different circuit boards. When the first circuit board 300 and the second circuit board 300′ are the same circuit board, they belong to the same circuit board.

The structure of the first electrical connector 100, the mating connector 200 and the first circuit board 300 will be introduced below as an example. Referring to FIG. 5 to FIG. 17, the first electrical connector 100 includes an first insulating body 1, a plurality of first conductive terminals 2 fixed to the first insulating body 1, a first movable component 3 installed on the first insulating body 1, an first elastic component 4 abutting against the first movable component 3, a first cable 5 electrically connected to the first conductive terminal 2, a first cover plate 6 that is fastened on the first insulating body 1 and at least partially abuts against the first cable 5, and a first pull strap 7 connected to the first movable component 3. The first pull strap 7 is configured to drive the first movable component 3 to overcome the force of the first elastic component 4, so that the first movable component 3 is able to move along a moving direction C (as shown in FIG. 5) perpendicular to the mating direction B.

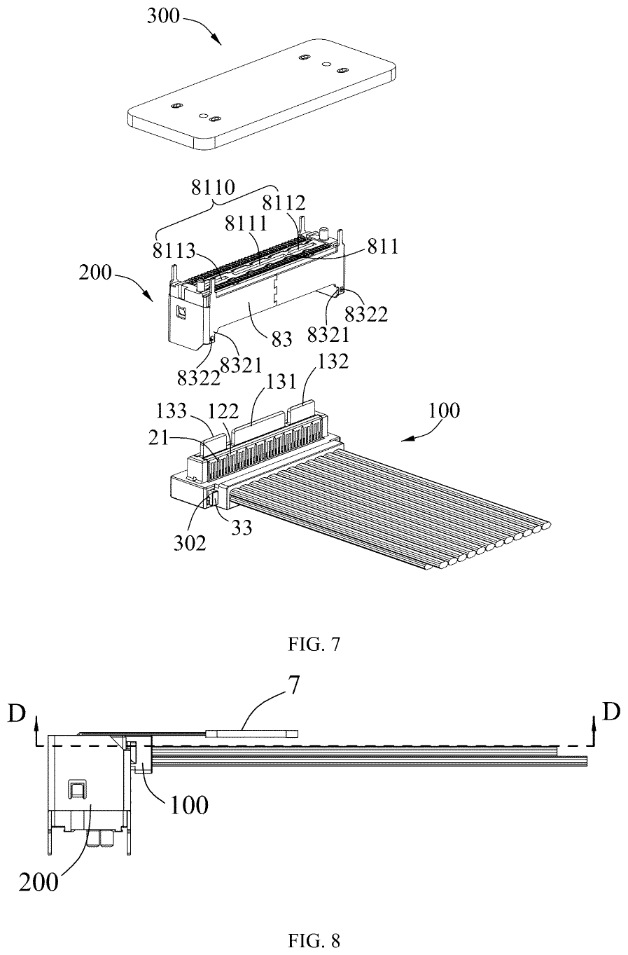

In the illustrated embodiment of the present disclosure, the first insulating body 1 includes a first main body 11, a first tongue plate 12 protruding downwardly from the first main body 11 along the mating direction B, and a first positioning plate 13 further protruding downwardly from the first tongue plate 12 along the mating direction B. In the illustrated embodiment of the present disclosure, a dimension of the first main body 11 in a front-rear direction/a second direction, a dimension of the first tongue plate 12 in the front-rear direction, and a dimension of the first positioning plate 13 in the front-rear direction become smaller in sequence, so that the first insulating body 1 is roughly of a stepped configuration. Referring to FIG. 6 and FIG. 7, the first positioning plate 13 includes a first positioning piece 131 located in a middle, a second positioning piece 132 located on one side of the first positioning piece 131, and a third positioning piece 133 located on another side of the first positioning piece 131. The second positioning piece 132 is spaced apart from the first positioning piece 131. The third positioning piece 133 is spaced apart from the first positioning piece 131. A dimension of the first positioning piece 131 along a left-right direction/a first direction is larger than a dimension of the second positioning piece 132 along the left-right direction. The dimension of the first positioning piece 131 along the left-right direction is also larger than a dimension of the third positioning piece 133 along the left-right direction. It is known that, the left-right direction is perpendicular to both the top-bottom direction and the front-rear direction. In the illustrated embodiment of the present disclosure, a distance between the first positioning piece 131 and the second positioning piece 132 is different from a distance between the first positioning piece 131 and the third positioning piece 133. This arrangement prevents the first electrical connector 100 from being inserted into the mating connector 200 at a wrong angle, so that a certain foolproof effect can be achieved.

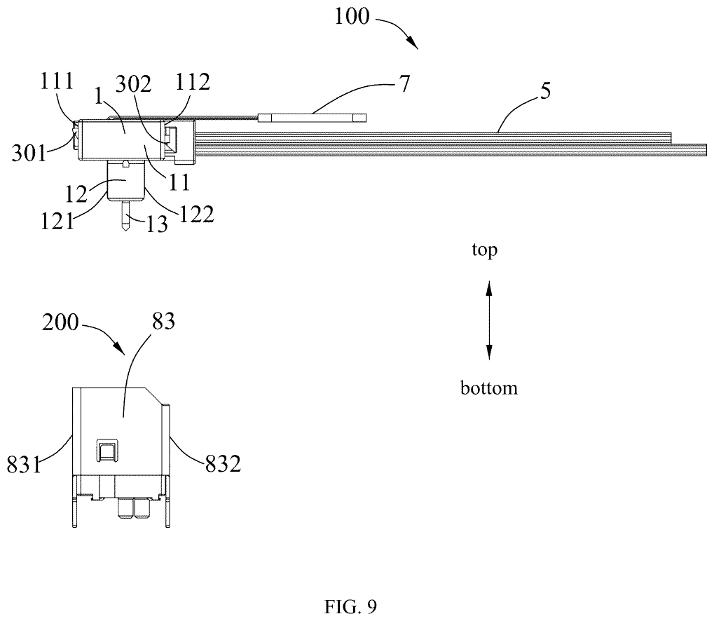

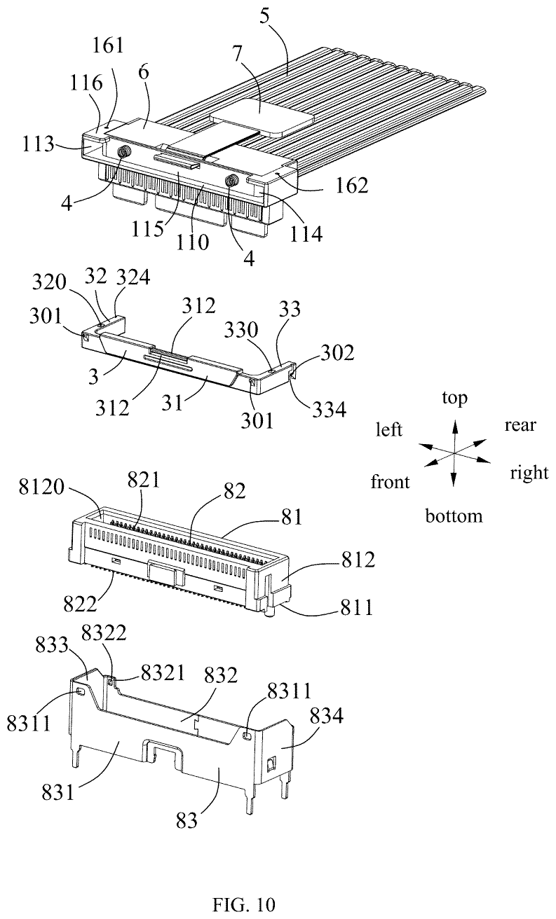

Referring to FIG. 9 and FIG. 10, the first main body 11 includes a first end wall 111 (for example, a front end wall) and a second end wall 112 (for example, a rear end wall) opposite to the first end wall 111. The first main body 11 further includes a receiving space 110 extending forwardly through the first end wall 111, a first receiving groove 113 located on one side (for example, a left side) of the receiving space 110, and a second receiving groove 114 located on another side (for example, a right side) of the receiving space 110. The receiving space 110 does not extend backwardly through the second end wall 112. The first main body 11 includes an inner wall surface 115 exposed to the receiving space 110. The first receiving groove 113 and the second receiving groove 114 extend through the second end wall 112 along the moving direction C.

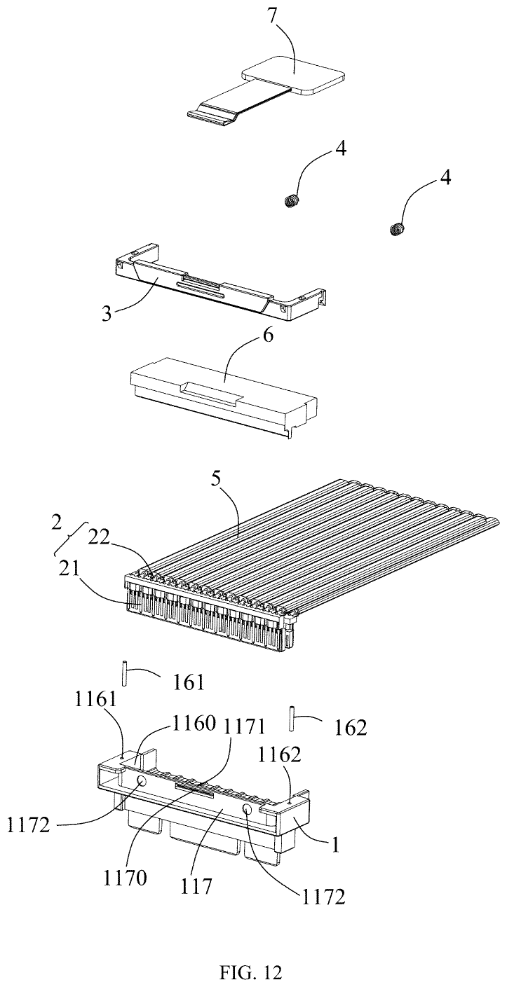

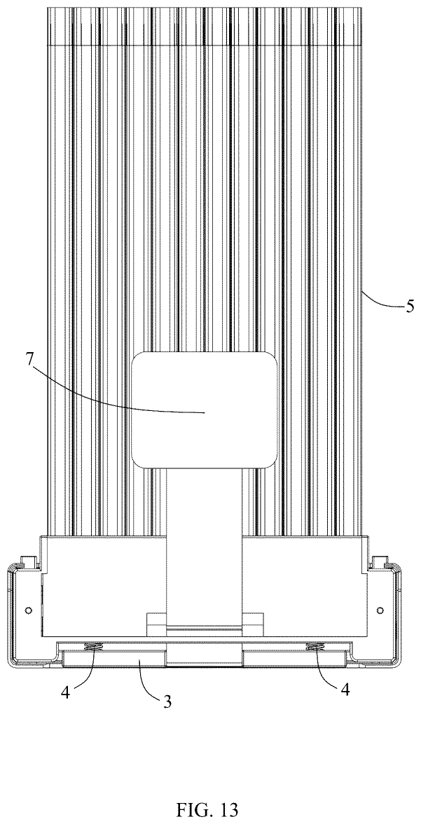

Referring to FIG. 12, the first main body 11 includes a top surface 116, an opening 1160 extending upwardly through the top surface 116, a first mounting hole 1161 extending upwardly through the top surface 116 and located on one side of the opening 1160, and a second mounting hole 1162 extending upwardly through the top surface 116 and located on another side of the opening 1160. The first main body 11 further includes a fixing plate 117 located between the first end wall 111 and the second end wall 112. In the illustrated embodiment of the present disclosure, the fixing plate 117 is a vertical plate. The fixing plate 117 includes a pull strap groove 1170 extending therethrough along the moving direction C, and a pull strap shaft 1171 located between an edge (for example, an upper edge) of the fixing plate 117 and the pull strap groove 1170. The first pull strap 7 extends through the pull strap groove 1170 along the moving direction C from a connection with the first movable component 3, and the pull strap is bent along the pull strap shaft 1171 and then extends out of the first main body 11. The fixing plate 117 further includes at least one receiving hole 1172. In the illustrated embodiment of the present disclosure, the number of the receiving holes 1172 is two. The receiving holes 1172 are exposed on a surface of the fixing plate 117 and face towards the first movable component 3. One end of the first elastic component 4 is disposed in the receiving hole 1172 and another end of the first elastic component 4 abuts against the first movable component 3.

Referring to FIG. 6 to FIG. 9, the first tongue plate 12 includes a first surface 121 and a second surface 122 which are disposed opposite to each other.

Referring to FIG. 12, each first conductive terminal 2 includes a mating portion 21 exposed to the first tongue plate 12 and a connection portion 22 electrically connected to the first cable 5. In the illustrated embodiment of the present disclosure, the mating portions 21 are in the shape of flat plates, and are exposed to the first surface 121 and the second surface 122, respectively. In a first embodiment of the present disclosure, the first conductive terminals 2 are insert-molded with the first insulating body 1. Of course, in a second embodiment, the first conductive terminals 2 can also be directly mounted to the first insulating body 1; or in a third embodiment, the first conductive terminals 2 and an insulating block are combined into a terminal module, and then the terminal module is mounted to the first insulating body 1. The fixing method of the first conductive terminals 2 and the first insulating body 1 is well known to those of ordinary skill in the art, and will not be described in detail in the present disclosure.

In the illustrated embodiment of the present disclosure, the first cable 5 extends beyond the first main body 11 along the moving direction C.

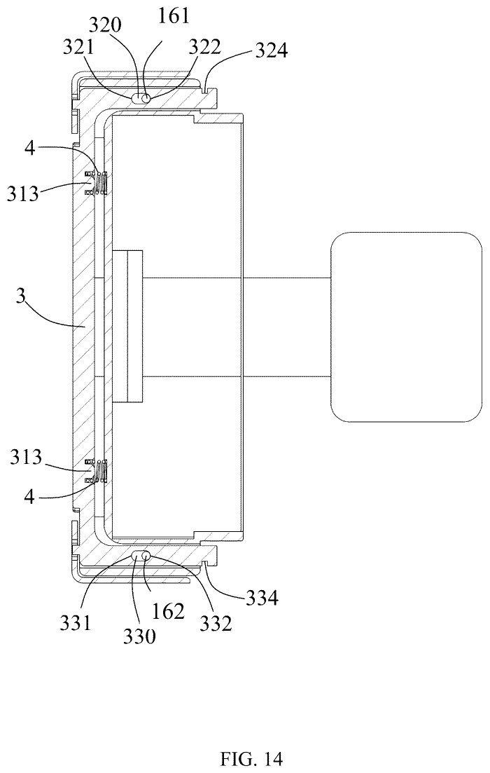

Referring to FIG. 10 and FIG. 14, the first movable component 3 is at least partially installed to the first main body 11. The first movable component 3 includes a base 31, a first ejector rod 32 extending backwardly from one side of the base 31, and a second ejector rod 33 extending backwardly from another side of the base 31. The base 31 is accommodated in the receiving space 110. Most of the first ejector rod 32 is accommodated in the first receiving groove 113 except a rear end of the first ejector rod 32 which extends out of the first receiving groove 113. Most of the second ejector rod 33 is accommodated in the second receiving groove 114 except a rear end of the second ejector rod 33 which extends out of the second receiving groove 114. Both the first ejector rod 32 and the second ejector rod 33 can be referred to as ejector rods which extend from the first end wall 111 to the second end wall 112 with the rear ends thereof protruding beyond the second end wall 112.

The base 31 includes two first locking protrusions 301 located on two sides (for example, left and right sides) of the base 31, respectively, so as to improve the mating retention force. The first locking protrusions 301 are integrally formed with the first main body 11 and extend forwardly beyond the first end wall 111. Of course, in another embodiment, the first locking protrusions 301 and the first main body 11 can also be manufactured separately, and then assembled and fixed together. In this case, the first locking protrusions 301 can be made of a material, for example, a wear-resistant material with better structural strength, different from that of the first main body 11. The base 31 further includes a pull strap connecting portion 312 to which the first pull strap 7 is connected. The first movable component 3 includes a transverse slot 311 extending through the base 31 along the moving direction C. The pull strap connecting portion 312 is located above the transverse slot 311. The pull strap connecting portion 312 is similar to a shaft portion, and is located between the transverse slot 311 and the edge (for example, the upper edge) of the base 31. One end of the first pull strap 7 passes through the transverse slot 311 and is sleeved around the pull strap connecting portion 312.

In an alternative embodiment of the present disclosure, the number of the first locking protrusion 301 can be only one and the first locking protrusion 301 protrudes forwardly from a middle part of the first end wall 111. The first locking protrusion 301 has same distances to both the left-front side of the base 31 and the right-front side of the base 31.

In the illustrated embodiment of the present disclosure, the first elastic component 4 is a compression spring installed between the base 31 and the inner wall surface 115 of the first main body 11. The number of the compression springs is two, and the two compression springs are arranged side by side to improve the stability of the moving element 3 when the moving element 3 is moving. Besides, referring to FIG. 14, in order to better positioning the compression spring, the base 31 is further provided with a positioning post 313 which is at least partially inserted into the compression spring.

The first movable component 3 further includes at least one second locking protrusion 302 protruding backwardly beyond the second end wall 112. In the illustrated embodiment of the present disclosure, the number of the second locking protrusions 302 is two. One of the second locking protrusions 302 is located at the rear end of the first ejector rod 32 away from the base 31. The one of the second locking protrusions 302 is located outside the first receiving groove 113 and protrudes toward the first receiving groove 113. A remaining one of the second locking protrusions 302 is located at the rear end of the second ejector rod 33 away from the base 31. The remaining one of the second locking protrusions 302 is located outside the second receiving groove 114 and protrudes toward the second receiving groove 114. The two second locking protrusions 302 are arranged in such a manner to improve an engagement force. The second locking protrusion 302 is integrally formed with a corresponding ejector rod to save cost. Of course, in another embodiment, the second locking protrusion 302 and the corresponding ejector rod can also be produced separately, and then assembled and fixed together. In this case, the second locking protrusion 302 can be made of a different material from that of the corresponding ejector rod. The first locking protrusions 301 and the second locking protrusions 302 are to lock with locking holes of the mating connector 200 to improve the mating retention force.

The two first locking protrusions 301 and the two second locking protrusions 302 are both arranged on the left side and the right side of the electrical connector, so that the present disclosure can realize a double-side locking purpose, thereby improving the mating retention force between the first electrical connector and the mating connector. In an alternative embodiment, the only one first locking protrusion 301 is arranged on the middle part of the first electrical connector and the two second locking protrusions 302 are arranged on the left side and the right side of the electrical connector, which can also realize the double-side locking purpose, thereby improving the mating retention force between the first electrical connector and the mating connector.

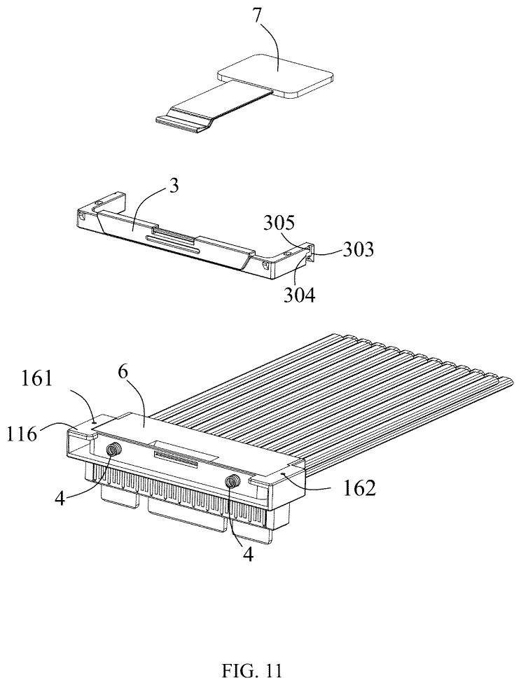

Referring to FIG. 10, FIG. 11 and FIG. 14, the first ejector rod 32 includes a first limiting groove 320 located in the middle, a first limiting surface 321 located at one end of the first limiting groove 320 along the moving direction C, and a second limiting surface 322 is located at another end of the first limiting groove 320 along the moving direction C. Compared with the second limiting surface 322, the first limiting surface 321 is closer to the first end wall 111.

Similarly, the second ejector rod 33 includes a second limiting groove 330 located in the middle, a third limiting surface 331 located at one end of the second limiting groove 330 along the moving direction C, and a fourth limiting surface 332 is located at another end of the second limiting groove 330 along the moving direction C. Compared with the fourth limiting surface 332, the third limiting surface 331 is closer to the first end wall 111.

Referring to FIG. 10, FIG. 11 and FIG. 14, the first ejector rod 32 further includes a first concave groove 324 located at a distal end (for example, a rear end) thereof, and the second ejector rod 33 further includes a second concave groove 334 located at a distal end (for example, a rear end) thereof. Both the first concave groove 324 and the second concave groove 334 are referred to as groove portions. Each groove portion has a first blocking wall 303 (for example, a rear blocking wall), a second blocking wall 304 (for example, a front lower blocking wall) and a third blocking wall 305 (for example, a front upper blocking wall). The second blocking wall 304 is located below the first blocking wall 303 to face the first blocking wall 303. The third blocking wall 305 is located above the first blocking wall 303 to face the first blocking wall 303. A large-diameter portion (not numbered) is formed between the first blocking wall 303 and the second blocking wall 304, and a small-diameter portion (not numbered) is formed between the first blocking wall 303 and the third blocking wall 305. A dimension of the small-diameter portion in the front-rear direction is smaller than a dimension of the large-diameter portion in the front-rear direction.

It should be noted that: in this embodiment, the groove portion extends vertically, and includes the small-diameter portion and the large-diameter portion. The small-diameter portion exists according to the manufacturing process of the groove portion. In another embodiment, the groove portion does not include the small-diameter portion and only includes the large-diameter portion, so that when the insertion plate portion 8321 is accommodated in the groove portion which only includes the large-diameter portion, the groove portion can move together with the first movable component 3 in the front-rear direction, and the second locking protrusion 302 can be inserted into the second locking hole 8322 of the insertion plate portion 8321 for engagement.

The second locking protrusion 302 protrudes from the bottom of the first blocking wall 303 toward the second blocking wall 304. The second locking protrusion 302 is spaced from the second blocking wall 304 by a distance. Because the first locking protrusion 301 also protrudes from the rear to the front, the first locking protrusion 301 and the second locking protrusion 302 in the present disclosure have the same forward protruding direction. Referring to FIG. 6, FIG. 9 and FIG. 10, the forward protruding direction is opposite to the moving direction C.

The first electrical connector 100 includes a first pin 151 fixed in the first mounting hole 1161 and a second pin 152 fixed in the second mounting hole 1162. The first pin 151 is inserted into the first limiting groove 320 and the second pin 152 is inserted into the second limiting groove 330. A dimension of the first limiting groove 320 is larger than a dimension of the first pin 151 along the moving direction C. A dimension of the second limiting groove 330 is larger than a dimension of the second pin 152 along the moving direction C. The first limiting surface 321 is used for engaging with the first pin 151, and the third limiting surface 331 is used for engaging with the second pin 152, so as to prevent the first movable component 3 from moving excessively along the moving direction C. The second limiting surface 322 is used for engaging with the first pin 151, and the fourth limiting surface 332 is used for engaging with the second pin 152, so as to prevent the first movable component 3 from returning excessively along an opposite direction of the moving direction C.

The first cover plate 6 is accommodated and fixed in the opening 1160 of the first main body 11, and the first pull strap 7 extends out of the first cover plate 6. The first cover plate 6 presses against the connection between the cables 5 and the first conductive terminals 2 (for example, welding portions of the cables 5 and the first conductive terminals 2), so as to play a protection role.

Referring to FIG. 4 to FIG. 10 and FIG. 15, the mating connector 200 includes a mating insulating body 81, a plurality of mating terminals 82 fixed to the mating insulating body 81, and a metal shell 83 enclosing the mating insulating body 81. The mating insulating body 81 includes a bottom wall 811 and a plurality of wall portions 812 perpendicular to the bottom wall 811. Referring to FIG. 7, the bottom wall 811 defines a positioning groove 8110 for accommodating the first positioning plate 13. Specifically, the positioning groove 8110 includes a first positioning groove 8111 for accommodating the first positioning piece 131, a second positioning groove 8112 for accommodating the second positioning piece 132, and a third positioning groove 8113 for accommodating the third positioning piece 133. The first positioning groove 8111, the second positioning groove 8112 and the third positioning groove 8113 all extend through the bottom wall 811.

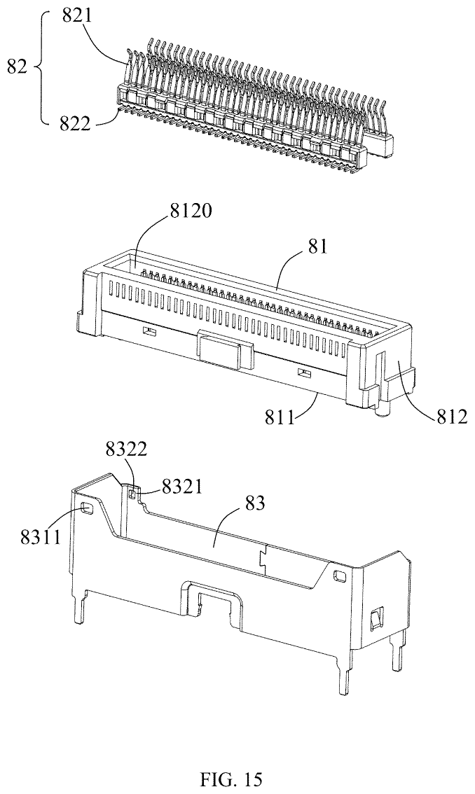

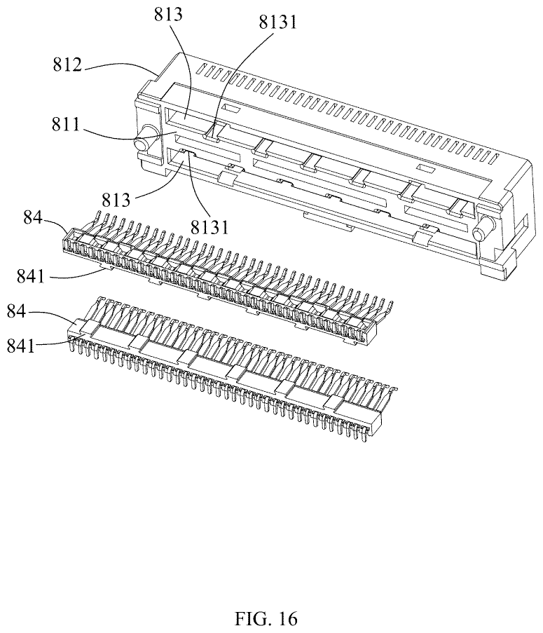

Referring to FIG. 15 and FIG. 16, the mating connector 200 includes a terminal fixing block 84 to which the mating terminals 82 are fixed. The mating insulating body 81 includes a terminal accommodating groove 813 in which the terminal fixing block 84 is fixed. The terminal fixing block 84 includes a first engaging portion 841. A second engaging portion 8131 is provided on one side of the terminal accommodating groove 813. The first engaging portion 841 and the second engaging portion 8131 are engaged with each other, so that the terminal fixing block 84 is fixed in the terminal accommodating groove 813. In the illustrated embodiment of the present disclosure, the first engaging portion 841 is a dovetail-shaped bump and the second engaging portion 8131 is a dovetail-shaped groove matching the dovetail-shaped bump.

In some embodiments, the number of the terminal fixing blocks 84 is two, and the two terminal fixing blocks 84 are symmetrical and spaced apart from each other. The mating terminals 82 are arranged in two symmetrical rows and the two rows of mating terminals 82 are fixed to the two terminal fixing blocks 84, respectively. Two terminal accommodating grooves 813 are provided, and the two terminal accommodating grooves 813 are symmetrical and spaced apart from each other. The two terminal accommodating grooves 813 are respectively formed between the bottom wall 811 and the two opposite wall portions 812. The two terminal fixing blocks 84 are fixed in the two terminal accommodating grooves 813. Each of the terminal fixing blocks 84 includes a plurality of first engaging portions 841. One side of each of the terminal accommodating grooves 813 includes a plurality of second engaging portions 8131 corresponding to the plurality of first engaging portions 841 respectively. Each of the first engaging portions 841 and the corresponding second engaging portions 8131 are engaged with each other, so that each terminal fixing block 84 is fixed in the corresponding terminal accommodating groove 813. The first engaging portions 841 are respectively disposed on the sides of the two terminal fixing blocks 84 facing each other. The second engaging portions 8131 are respectively disposed on opposite sides of the bottom wall 811 facing the two terminal accommodating grooves 813.

Referring to FIG. 10 and FIG. 15, the wall portions 812 are enclosed to form a mating slot 8120 for receiving the first tongue plate 12. The mating terminals 82 are arranged in two rows. Each mating terminal 82 includes an elastic mating arm 821 and a mounting tail 822. The mounting tail 822 is used for being mounted on a first circuit board 300. The elastic mating arm 821 extends into the mating slot 8120 for being in contact with the mating portion 21.

The metal shell 83 includes a first side wall 831, a second side wall 832, a first connecting wall 833, and a second connecting wall 834. The second side wall 832 is disposed opposite to the first side wall 831. The first connecting wall 833 connects one side of the first side wall 831 and one side of the second side wall 832. The second connecting wall 834 connects another side of the first side wall 831 and another side of the second side wall 832. The first side wall 831 defines a first locking hole 8311 engaged with the first locking protrusion 301. The second side wall 832 includes two insertion plate portion 8321 at a corner adjacent to the first connecting wall 833 and at a corner adjacent to the second connecting wall 834. That is to say, each of the left and right sides of the second side wall 832 includes one insertion plate portion 8321. The insertion plate portion 8321 defines a second locking hole 8322 matched with the second locking protrusion 302. The insertion plate portion 8321 is integrally formed on the second side wall 832. The insertion plate portion 8321 and the first connecting wall 833 are integrally formed, and the insertion plate portion 8321 and the second connecting wall 834 are also integrally formed without any gap. Therefore, the insertion plate portion 8321 has no elasticity.

When the first electrical connector 100 is inserted into the mating connector 200, the first positioning plate 13 is correspondingly accommodated in the positioning groove 8110, the first tongue plate 12 is correspondingly accommodated in the mating slot 8120, and the mating portions 21 of the first conductive terminals 2 correspondingly contact the elastic mating arms 821 of the mating terminals 82. With the insertion of the first electrical connector 100, the inclined surface of the first locking protrusion 301 abuts against the first side wall 831, and the inclined surface of the second locking protrusion 302 abuts against the second side wall 832. The first movable component 3 overcomes the force of the first elastic component 4, and shrinks inward by a certain distance along the moving direction C. When the first locking protrusion 301 moves downwardly to the first locking hole 8311, and the second locking protrusion 302 moves downwardly to the second locking hole 8322, the elastic force of the first elastic component 4 is released, so that the first movable component 3 moves backwardly in the direction opposite to the moving direction C. The first locking protrusion 301 protrudes forwardly into the first locking hole 8311, and the second locking protrusion 302 protrudes forwardly and protrudes into the second locking hole 8322, thereby realizing the locking of the first electrical connector 100 and the mating connector 200.

In the present disclosure, by providing the first locking protrusion 301 and the second locking protrusion 302 on two sides, two-side locking in the front-rear direction/the second direction can be achieved, thereby improving the mating reliability, and reducing the risk of the first electrical connector 100 and the mating connector 200 becoming loose or tilted.

When the first electrical connector 100 and the mating connector 200 need to be unlocked, an external force is applied to pull the first pull strap 7, and the first pull strap 7 generates a component force along the moving direction C, and the component force in this direction overcomes the force of the first elastic component 4, so that the first movable component 3 moves along the moving direction C. The first ejector rod 32 and the second ejector rod 33 move away from the insertion plate portion 8321 backwards, so that the second locking protrusion 302 and the second locking hole 8322 are disengaged from each other. The first locking protrusion 301 and the first locking hole 8311 are also separated from each other. In other words, the first electrical connector 100 and the mating connector 200 are unlocked on two sides. As a result, the first electrical connector 100 can be pulled out of the mating connector 200 by applying another force or by an upward component force exerted on the first pull strap 7.

The insertion plate portion 8321 is accommodated in the large-diameter portion of the groove portion in both the locked state of the first electrical connector 100 and the mating connector 200, and the unlocked state of the first electrical connector 100 and the mating connector 200. When the first movable component 3 drives the second locking protrusion 302 to move, and the second locking protrusion 302 cooperates with the second locking hole 8322, the insertion plate portion 8321 is in contact with the first blocking wall 303, and the insertion plate portion 8321 is separated from the second blocking wall 304. When the first movable component 3 drives the second locking protrusion 302 to move, and the second locking protrusion 302 and the second locking hole 8322 are disengaged from each other, the insertion plate portion 8321 is in contact with the second blocking wall 304, and the insertion plate portion 8321 is separated from the first blocking wall 303.

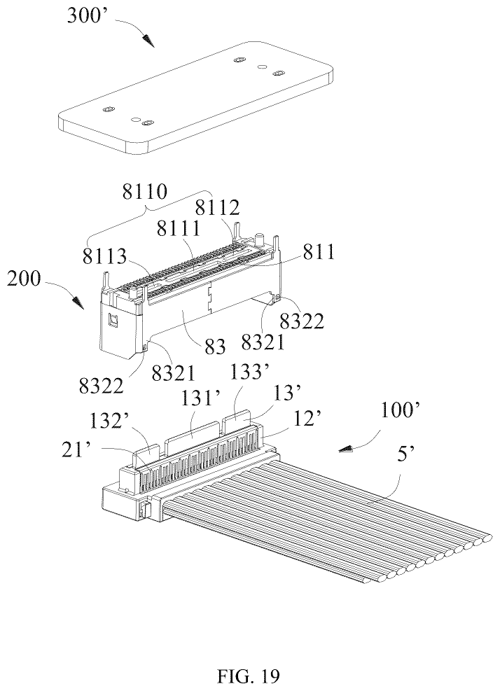

Referring to FIG. 18 and FIG. 19, the second electrical connector 100′ includes a second insulating body 1′, a plurality of second conductive terminals 2′ fixed to the second insulating body 1′, a second movable component 3′ installed on the second insulating body 1′, a second elastic component (not shown) for abutting against the second movable component 3, a second cable 5′ electrically connected to the second conductive terminal 2′, a second cover plate 6′ fastened to the second insulating body 1′ and at least partially abutting against the second cable 5′, and a second pull strap 7′ connected to the second movable component 3′.

The second insulating body 1′ includes a second main body 11′, a second tongue plate 12′ protruding downwardly beyond the second main body 11′ along the mating direction B, and a second positioning plate 13′ further protruding downwardly beyond the second tongue plate 12′ along the mating direction B. Each second conductive terminal 2′ includes a second mating portion 21′ provided on inner and outer surfaces of the second tongue plate 12′. In the illustrated embodiment of the present disclosure, a dimension of the second main body 11′ along a front-rear direction/a second direction, a dimension of the second tongue plate 12′ along the front-rear direction, and the dimension of the second positioning plate 13′ along the front-rear direction become smaller in sequence, so that the second insulating body 1′ is roughly of a stepped configuration. In the illustrated embodiment of the present disclosure, referring to FIG. 18 and FIG. 19, the second positioning plate 13′ includes a fourth positioning piece 131′ located in a middle, a fifth positioning piece 132′ located on one side of the fourth positioning piece 131′ and spaced apart from the fourth positioning piece 131′, and a sixth positioning piece 133′ located on another side of the fourth positioning piece 131′ and spaced apart from the fourth positioning piece 131′. A dimension of the fourth positioning piece 131′ along a left-right direction/a first direction is larger than a dimension of the fifth positioning piece 132′ along the left-right direction. The dimension of the fourth positioning piece 131′ along the left-right direction is also larger than a dimension of the sixth positioning piece 133′ along the left-right direction. In the illustrated embodiment of the present disclosure, a distance between the fourth positioning piece 131′ and the fifth positioning piece 132′ is different from a distance between the fourth positioning piece 131′ and the sixth positioning piece 133′. This arrangement can play a certain anti-fooling role, so that the second electrical connector 100′ can be inserted into the another mating connector 200′ at a certain angle.

It is understandable to those skilled in the art that the second electrical connector 100′ in the electrical connector assembly of the first embodiment of the present disclosure is substantially the same as the first electrical connector 100. For the same or corresponding structures, reference can be made to the description of the first electrical connector 100, which will not be described again in the present disclosure.

Referring to FIG. 6 and FIG. 18, it is understandable to those skilled in the art that when the mating connector 200 is installed on the first circuit board 300 in the first position and is mated with the first electrical connector 100, and when the another mating connector 200′ is installed on the second circuit board 300′ in the second position and is mated with the second electrical connector 100′, an outlet direction of the first cable 5 of the first electrical connector 100 is the same as an outlet direction of the second cable 5′ of the second electrical connector 100′. For example, the outlet direction of the first cable 5 and the outlet direction of the second cable 5′ both extend along the moving direction C. With this arrangement, the first cable 5 and the second cable 5′ can be arranged together, avoiding the cable from being folded back and reducing the mating height, which is beneficial to reducing the overall height of the electrical connector assembly.

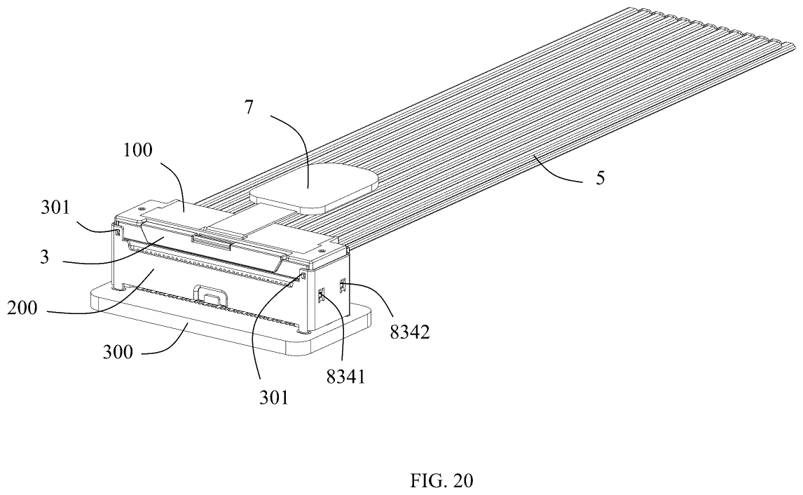

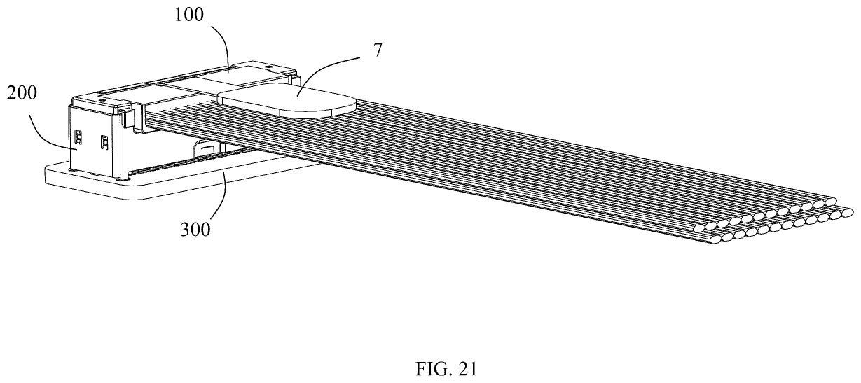

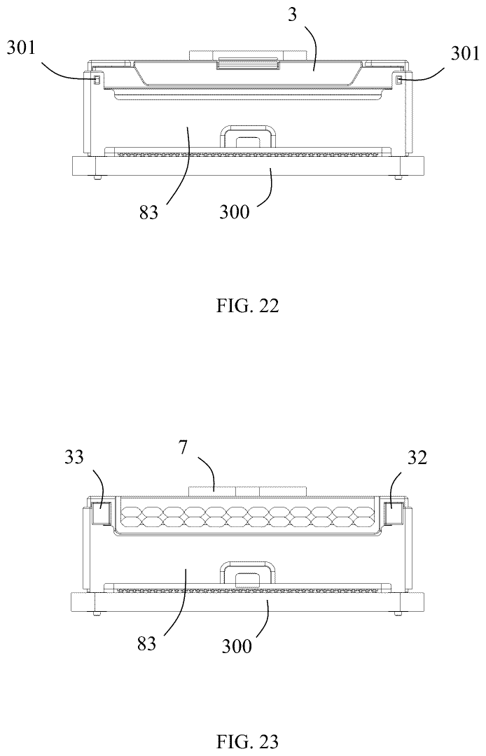

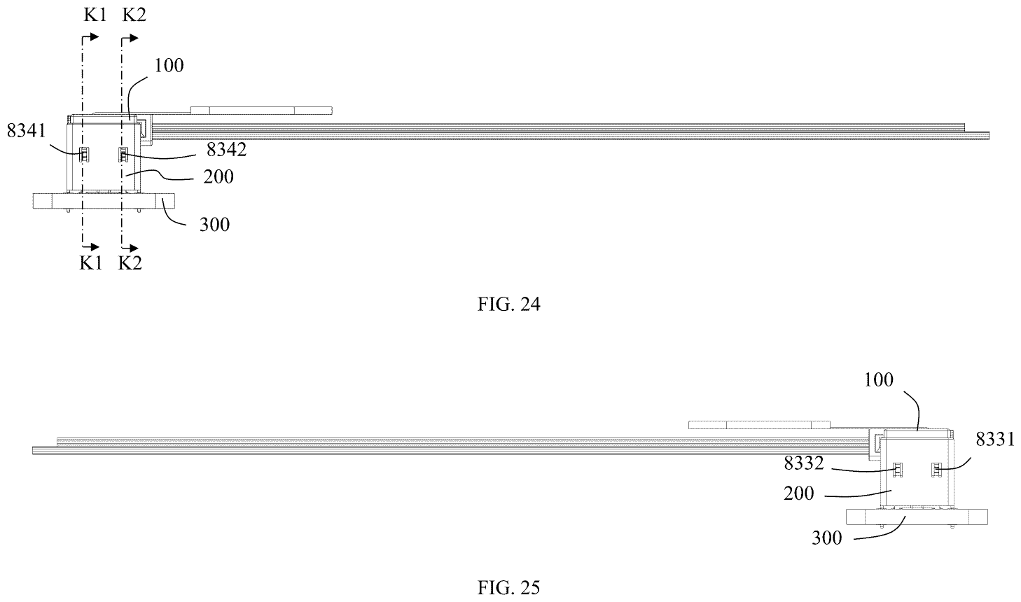

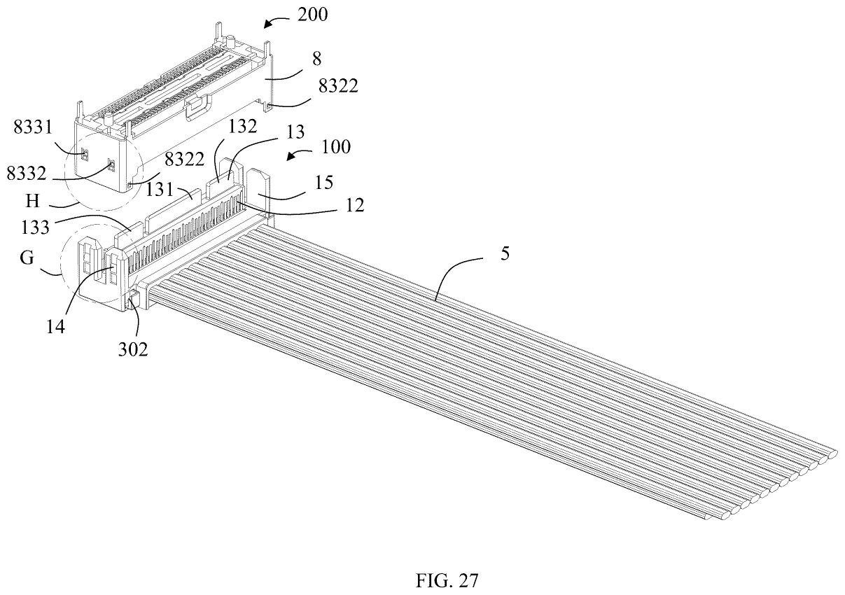

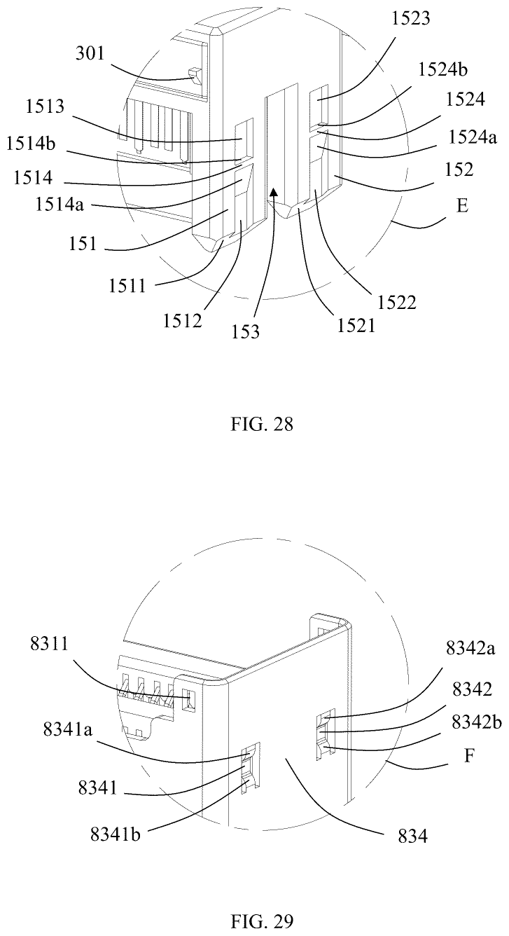

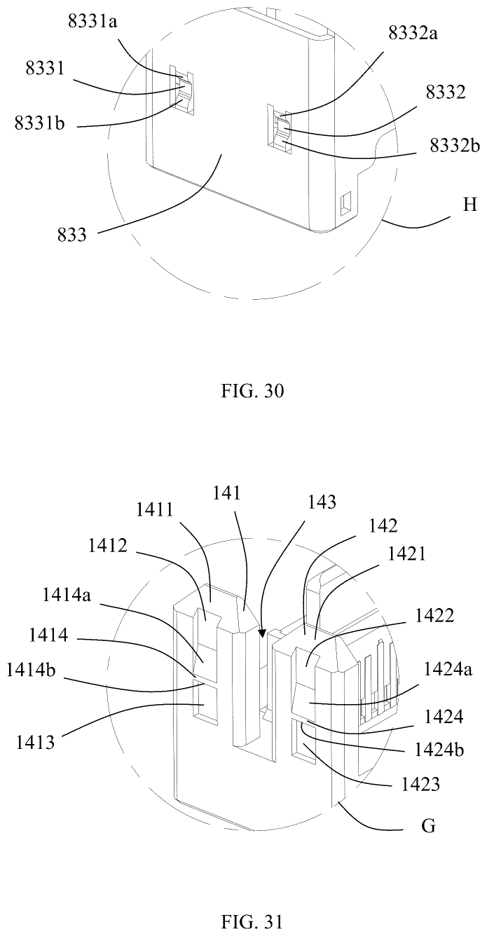

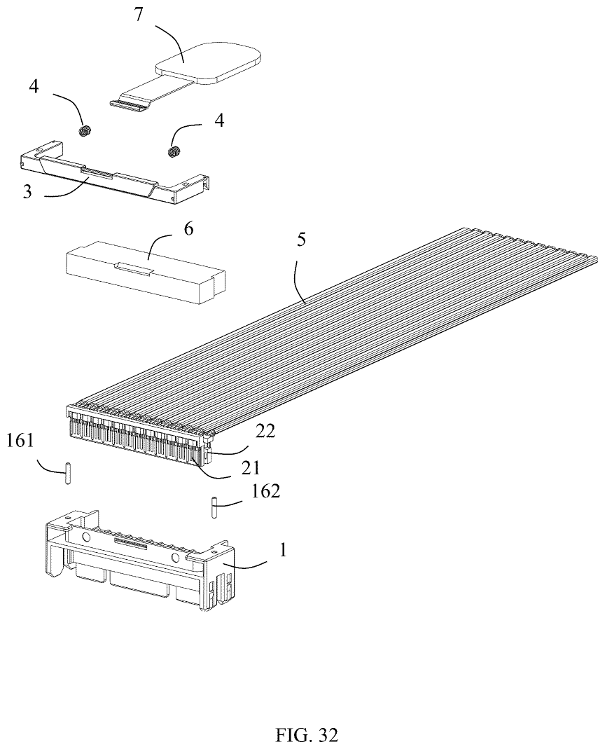

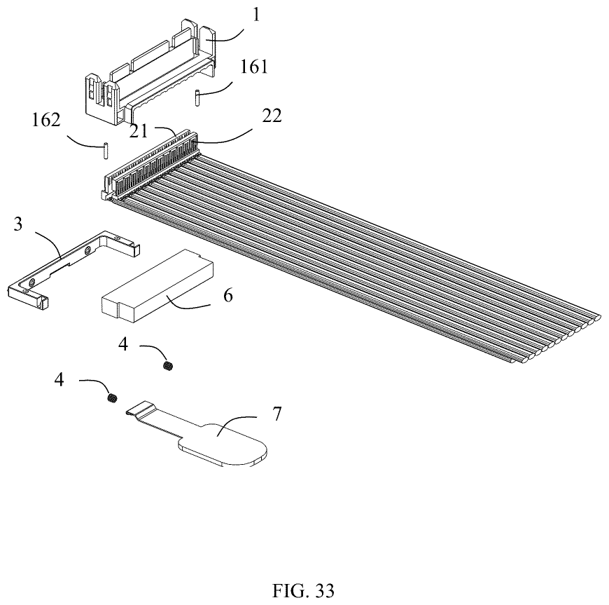

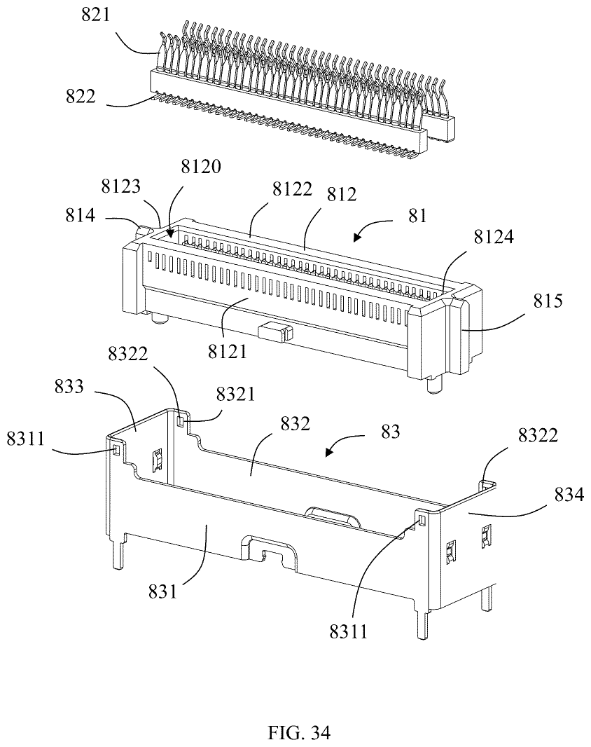

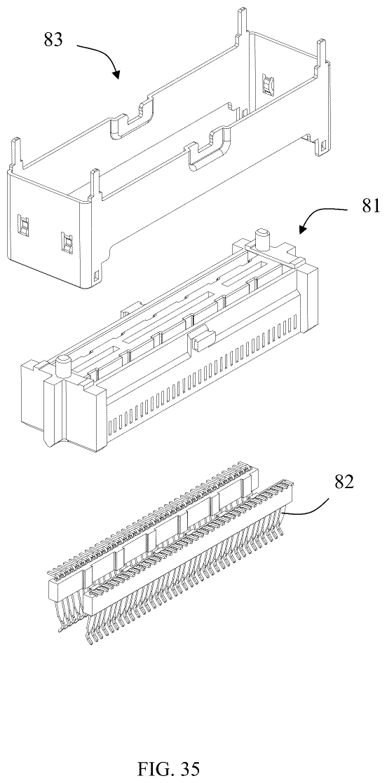

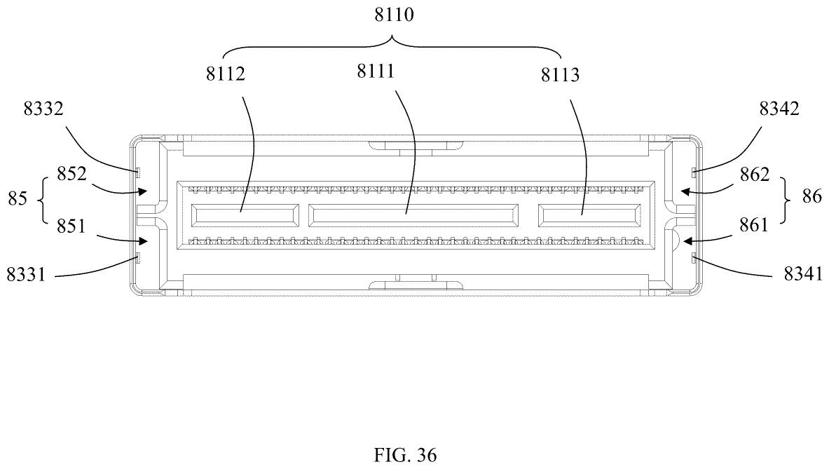

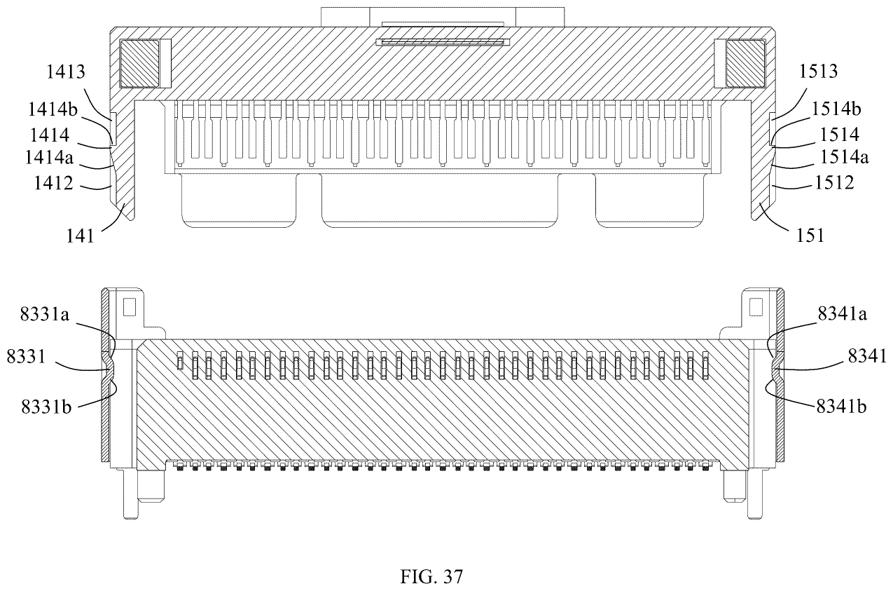

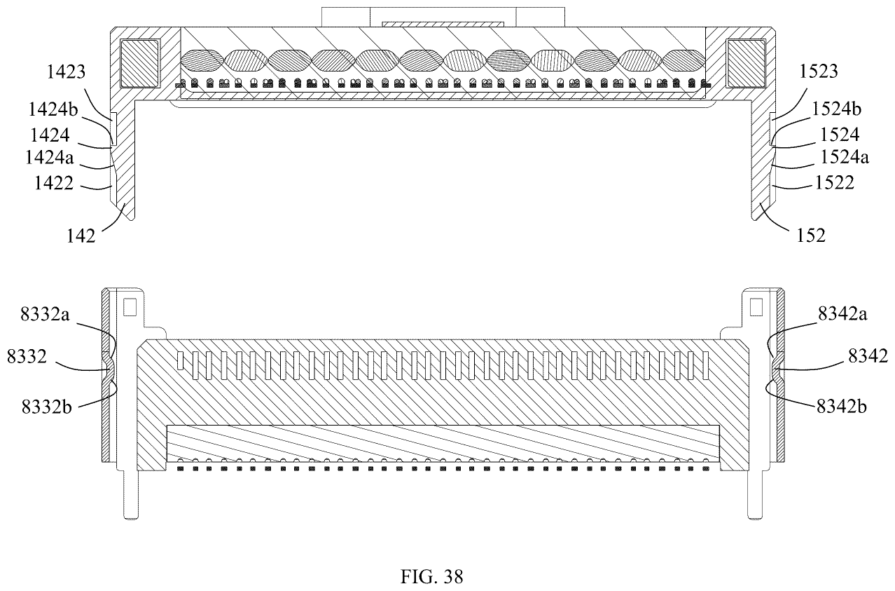

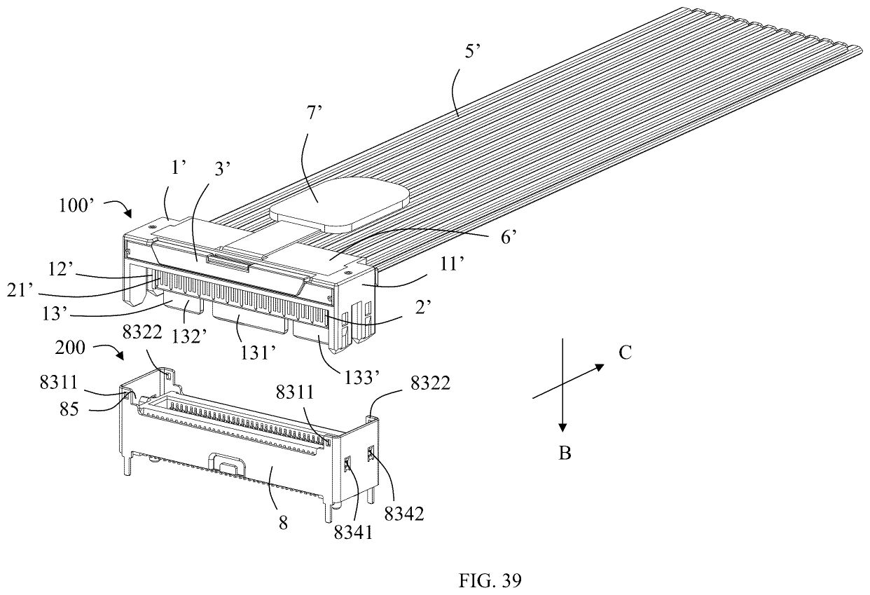

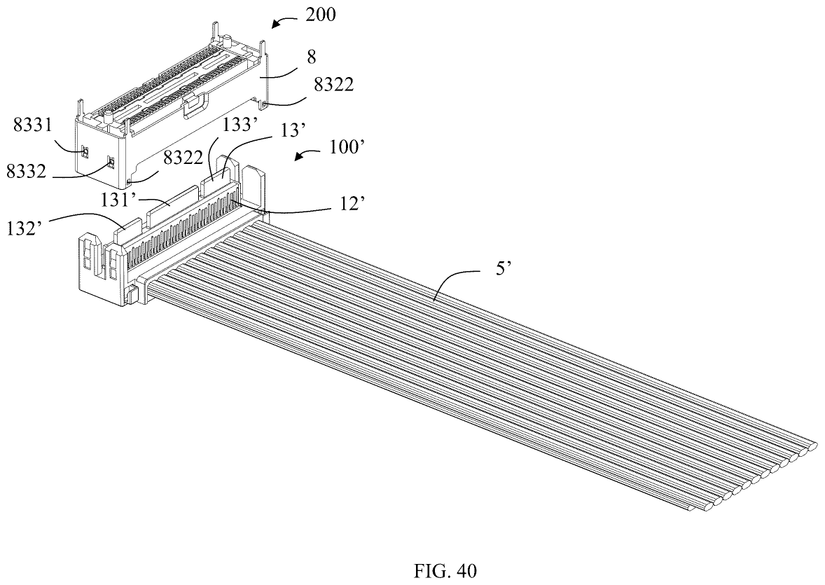

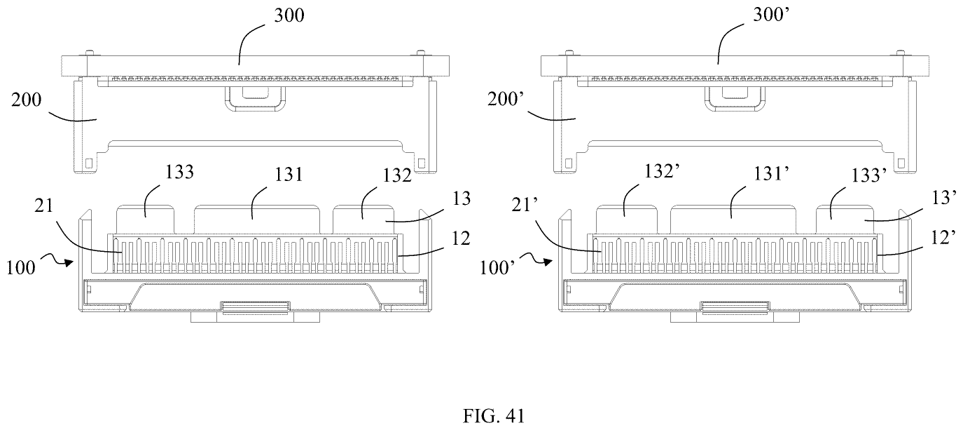

Referring to FIG. 20 to FIG. 41, in a second embodiment of the present disclosure, it discloses an electrical connector assembly, which includes a first electrical connector 100, a mating connector 200 for mating with the first electrical connector 100, a second electrical connector 100′, and another mating connector 200′ for mating with the second electrical connector 100′. In the illustrated embodiment of the present disclosure, the first electrical connector 100 and the second electrical connector 100′ are cable connectors. The mating connector 200 is a board-end connector configured to be installed on a first circuit board 300 in a first position. The another mating connector 200′ is a board-end connector configured to be installed on a second circuit board 300′ in a second position. The first electrical connector 100 is configured to mate with the mating connector 200 along the mating direction B (for example, a top-to-bottom direction) to achieve data transmission. Referring to FIG. 39, the second electrical connector 100′ is configured to mate with another mating connector 200′ along the mating direction B to achieve data transmission.

In the illustrated embodiment of the present disclosure, the mating connector 200 and the another mating connector 200′ are connectors with the same structure, except that their installation angles differ by 180 degrees. In other words, it can be understood that the another mating connector 200′ is formed by rotating the mating connector 200 by 180 degrees in a plane where the first circuit board 300 is located.

The first circuit board 300 and the second circuit board 300′ may be the same or different circuit boards. When the first circuit board 300 and the second circuit board 300′ are the same circuit board, they belong to the same circuit board.

The structure of the first electrical connector 100 in the second embodiment of the present disclosure is similar to that of the first electrical connector 100 in the first embodiment. For the first electrical connector 100 in the second embodiment of the present disclosure, reference may be made to the description of the first electrical connector 100 in the first embodiment, in which the same reference numbers indicate the same or corresponding technical features. The mating connector 200 in the second embodiment of the present disclosure has a similar structure to the mating connector 200 in the first embodiment. For the mating connector 200 in the second embodiment of the present disclosure, reference may be made to the description of the mating connector 200 in the first embodiment, in which the same reference numbers indicate the same or corresponding technical features.

The first electrical connector 100 in the second embodiment of the present disclosure is briefly described as follows. The first electrical connector 100 includes an first insulating body 1, a plurality of first conductive terminals 2 fixed to the first insulating body 1, a first movable component 3 installed on the first insulating body 1, an first elastic component 4 abutting against the first movable component 3, a first cable 5 electrically connected to the first conductive terminal 2, a first cover plate 6 that is fastened on the first insulating body 1 and at least partially abuts against the first cable 5, and a first pull strap 7 connected to the first movable component 3.

The first electrical connector 100 in the second embodiment of the present disclosure is similar to the first electrical connector 100 in the first embodiment. The main difference is that the first insulating body 1 of the first electrical connector 100 in the second embodiment of the present disclosure includes a first main body 11, a first tongue plate 12 extending downwardly from the first main body 11 along the mating direction B, a first positioning plate 13 further extending downwardly from the first tongue plate 12 along the mating direction B, and a first extension portion 14 and a second extension portion 15 which extend downwardly from the first main body 11 along the mating direction B.

In the second embodiment illustrated in the present disclosure, the first extension portion 14 and the second extension portion 15 are located on the left and right sides of the first main body 11. The first extension portion 14 and the second extension portion 15 are integrally formed with the first main body 11. The first extension portion 14 includes a first extension protrusion 141, a second extension protrusion 142, and a first slot 143 located between the first extension protrusion 141 and the second extension protrusion 142. In the second embodiment illustrated in the present disclosure, the first extension protrusion 141 and the second extension protrusion 142 are identical and symmetrically disposed on two sides of the first slot 143.

Specifically, the first extension protrusion 141 includes a first guide inclined surface 1411 located at a free end thereof, a first recessed groove 1412 extending downwardly through the first guide inclined surface 1411 along the mating direction B, a first retaining groove 1413 spaced apart from the first recessed groove 1412 along the mating direction B, and a first partition wall 1414 located between the first recessed groove 1412 and the first retaining groove 1413 along the mating direction B. In the second embodiment illustrated in the present disclosure, a portion of the first partition wall 1414 exposed in the first recessed groove 1412 is provided with a first inclined surface 1414a. Another portion of the first partition wall 1414 exposed in the first retaining groove 1413 is provided with a first flat surface 1414b.

The second extension protrusion 142 includes a second guide inclined surface 1421 located at a free end thereof, a second recessed groove 1422 extending downwardly through the second guide inclined surface 1421 along the mating direction B, a second retaining groove 1423 spaced apart from the second recessed groove 1422 along the mating direction B, and a second partition wall 1424 located between the second recessed groove 1422 and the second retaining groove 1423 along the mating direction B. In the second embodiment illustrated in the present disclosure, a portion of the second partition wall 1424 exposed in the second recessed groove 1422 is provided with a second inclined surface 1424a. Another portion of the second partition wall 1424 exposed in the second retaining groove 1423 is provided with a second flat surface 1424b.

The second extension portion 15 includes a third extension protrusion 151, a fourth extension protrusion 152, and a second slot 153 located between the third extension protrusion 151 and the fourth extension protrusion 152. In the second embodiment illustrated in the present disclosure, the third extension protrusion 151 and the fourth extension protrusion 152 are identical and symmetrically disposed on two sides of the second slot 153.

Specifically, the third extension protrusion 151 includes a third guide inclined surface 1511 located at a free end thereof, a third recessed groove 1512 extending downwardly through the third guide inclined surface 1511 along the mating direction B, a third retaining groove 1513 spaced apart from the third recessed groove 1512 along the mating direction B, and a third partition wall 1514 is located between the third recessed groove 1512 and the third retaining groove 1513 along the mating direction B. In the second embodiment illustrated in the present disclosure, a portion of the third partition wall 1514 exposed in the third recessed groove 1512 is provided with a third inclined surface 1514a. Another portion of the third partition wall 1514 exposed in the third retaining groove 1513 is provided with a third flat surface 1514b.

The fourth extension protrusion 152 includes a fourth guide inclined surface 1521 located at a free end thereof, a fourth recessed groove 1522 extending downwardly along the mating direction B of the fourth guide inclined surface 1521, a fourth retaining groove 1523 spaced apart from the fourth recessed groove 1522 along the mating direction B, and a fourth partition wall 1524 located between the fourth recessed groove 1522 and the fourth retaining groove 1523 along the mating direction B. In the second embodiment illustrated in the present disclosure, a portion of the fourth partition wall 1524 exposed in the fourth recessed groove 1522 is provided with a fourth inclined surface 1524a. Another portion of the fourth partition wall 1524 exposed in the fourth retaining groove 1523 is provided with a fourth flat surface 1524b.

In the second embodiment of the present disclosure, the first retaining groove 1413, the second retaining groove 1423, the third retaining groove 1513 and the fourth retaining groove 1523 are all rectangular. The first retaining groove 1413, the second retaining groove 1423, the third retaining groove 1513 and the fourth retaining groove 1523 serve as a first locking structure, a second locking structure, a third locking structure and a fourth locking structure, respectively, to lock with the mating connector 200. Of course, it is understandable to those skilled in the art that the first locking structure, the second locking structure, the third locking structure and the fourth locking structure can also adopt other forms (for example, locking protrusions) to lock with the mating connector 200.

In the second embodiment of the present disclosure, the mating connector 200 includes a mating insulating body 81, a plurality of mating terminals 82 fixed to the mating insulating body 81, and a metal shell 83 enclosing the mating insulating body 81. The mating insulating body 81 includes a bottom wall 811 and a plurality of wall portions 812 perpendicular to the bottom wall 811.

In the second embodiment of the present disclosure, the plurality of wall portions 812 include a first wall portion 8121, a second wall portion 8122 disposed opposite to the first wall portion 8121, a first connecting wall portion 8123 connecting one side of the first wall portion 8121 and one side of the second wall portion 8122, and a second connecting wall portion 8124 connecting another side of the first wall portion 8121 and another side of the second wall portion 8122. The mating insulating body 81 further includes first protrusion 814 extending from the first connecting wall portion 8123 in a left-right direction/a first direction away from the second connecting wall portion 8124, and a second protrusion 815 extending from the second connecting wall portion 8124 in the left-right direction away from the first connecting wall portion 8123.

In the second embodiment of the present disclosure, the first wall portion 8121 corresponds to the first side wall 831, the second wall portion 8122 corresponds to the second side wall 832, the first connecting wall portion 8123 corresponds to the first connecting wall 833, and the second connecting wall portion 8124 corresponds to the second connecting wall 834. The mating connector 200 includes a first accommodating groove 85 located between the metal shell 83 and the mating insulating body 81, and a second accommodating groove 86 located between the metal shell 83 and the mating insulating body 81.

In the second embodiment illustrated of the present disclosure, the first accommodating groove 85 is located between the first connecting wall portion 8123 and the first connecting wall 833 in the left-right direction. The first protrusion 814 is located between the first connecting wall portion 8123 and the first connecting wall 833 along a front-rear direction/a second direction. The first protrusion 814 divides the first accommodating groove 85 into a first accommodating sub-groove 851 and a second accommodating sub-groove 852.

Similarly, in the second illustrated embodiment of the present disclosure, the second accommodating groove 86 is located between the second connecting wall portion 8124 and the second connecting wall 834 along the left-right direction. The second protrusion 815 is located between the second connecting wall portion 8124 and the second connecting wall 834 in the front-rear direction. The second protrusion 815 divides the second accommodating groove 86 into a third accommodating sub-groove 861 and a fourth accommodating sub-groove 862.

In the second embodiment of the present disclosure, the first connecting wall 833 includes a first locking protrusion 8331 protruding inwardly into the first accommodating sub-groove 851 and a second locking protrusion 8332 protruding inwardly into the second accommodating sub-groove 852. In the second embodiment of the present disclosure, the first locking protrusion 8331 and the second locking protrusion 8332 are stamped inwardly from the first connecting wall 833. In the second embodiment of the present disclosure, the first locking protrusion 8331 and the second locking protrusion 8332 are simply supported beams, that is, two ends thereof are both connected to the first connecting wall 833 to provide sufficient rigidity. In the second embodiment illustrated in the present disclosure, the first locking protrusion 8331 is provided with a first insertion guide portion 8331a and a first extraction guide portion 8331b which are located at two ends thereof, respectively. The second locking protrusion 8332 is provided with a second insertion guide portion 8332a and a second extraction guide portion 8332b which are located at two ends thereof, respectively.

Similarly, in the second embodiment of the present disclosure, the second connecting wall 834 includes a third locking protrusion 8341 protruding inwardly into the third accommodating sub-groove 861 and a fourth locking protrusion 8342 protruding inwardly into the fourth accommodating sub-groove 862. In the second embodiment illustrated in the present disclosure, the third locking protrusion 8341 and the fourth locking protrusion 8342 are stamped inwardly from the second connecting wall 834. In the second embodiment of the present disclosure, the third locking protrusion 8341 and the fourth locking protrusion 8342 are simply supported beams, that is, two ends thereof are both connected to the second connecting wall 834 to provide sufficient rigidity. In the second embodiment illustrated in the present disclosure, the third locking protrusion 8341 is provided with a third insertion guide portion 8341a and a third extraction guide portion 8341b which are located at two ends thereof, respectively. The fourth locking protrusion 8342 is provided with a fourth insertion guide portion 8342a and a fourth extraction guide portion 8342b which are located at two ends thereof, respectively.

In the second embodiment of the present disclosure, the first insertion guide portion 8331a, the second insertion guide portion 8332a, the third insertion guide portion 8341a and the fourth insertion guide portion 8342a are all inclined surfaces or arc-shaped surfaces. When the first electrical connector 100 is inserted into the mating connector 200, the first insertion guide portion 8331a, the second insertion guide portion 8332a, the third insertion guide portion 8341a and the fourth insertion guide portion 8342a are configured to abut against the first partition wall 1414, the second partition wall 1424, the third partition wall 1514 and the fourth partition wall 1524, respectively, so that the first locking protrusion 8331, the second locking protrusion 8332, the third locking protrusion 8341 and the fourth locking protrusion 8342 can smoothly cross the first partition wall 1414, the second partition wall 1424, the third partition wall 1514 and the fourth partition wall 1524, respectively, so as to be locked in the first retaining groove 1413, the second retaining groove 1423, the third retaining groove 1513 and the fourth retaining groove 1523, respectively. In the second embodiment of the present disclosure, the first retaining groove 1413, the second retaining groove 1423, the third retaining groove 1513 and the fourth retaining groove 1523 are respectively adapted to the first locking protrusion 8331, the second locking protrusion 8332, the third locking protrusion 8341 and the fourth locking protrusion 8342, respectively, so as to reduce shaking and improve mating stability when the first locking protrusion 8331, the second locking protrusion 8332, the third locking protrusion 8341 and the fourth locking protrusion 8342 are respectively locked in the first retaining groove 1413, the second retaining groove 1423, the third retaining groove 1513 and the fourth retaining groove 1523, respectively.

Similarly, in the second illustrated embodiment of the present disclosure, the first extraction guide portion 8331b, the second extraction guide portion 8332b, the third extraction guide portion 8341b and the fourth extraction guide portion 8342b are inclined surfaces or arc-shaped surfaces. When the first electrical connector 100 is pulled out from the mating connector 200, the first extraction guide portion 8331b, the second extraction guide portion 8332b, the third extraction guide portion 8341b and the fourth extraction guide portion 8342b abut against the first partition wall 1414, the second partition wall 1424, the third partition wall 1514, and the fourth partition wall 1524, respectively, so that the first locking protrusion 8331, the second locking protrusion 8332, the third locking protrusion 8341 and the fourth locking protrusion 8342 can smoothly cross the first partition wall 1414, the second partition wall 1424, the third partition wall 1514 and the fourth partition wall 1524, respectively, and enter the first recessed groove 1412, the second recessed groove 1422, the third recessed groove 1512 and the fourth recessed groove 1522, respectively, to achieve unlocking on both the left and right sides.

Besides, when the first electrical connector 100 is inserted into the mating connector 200, the first positioning plate 13 is correspondingly inserted into the positioning groove 8110, the first tongue plate 12 is correspondingly inserted into the mating slot 8120, and the mating portions 21 of the first conductive terminals 2 are in contact with the elastic mating arms 821 of the mating terminals 82. When the first electrical connector 100 is inserted into the mating connector 200, the inclined surface of the first locking protrusion 301 and the inclined surface of the second locking protrusion 302 abut against the first side wall 831 and the second side wall 832, respectively. The first movable component 3 overcomes a force of the first elastic component 4 and moves inwardly for a certain distance along the moving direction C. When the first locking protrusion 301 and the second locking protrusion 302 move downwardly to correspond to the first locking hole 8311 and the second locking hole 8322, respectively, the first elastic component 4 recovers its elastic force, causing the first movable component 3 to return in a direction opposite to the moving direction C. At this time, both the first locking protrusion 301 and the second locking protrusion 302 protrude forwardly into the first locking hole 8311 and the second locking hole 8322, respectively, to realize the locking of the first electrical connector 100 and the mating connector 200 at the front and rear sides.

At the same time, when the first electrical connector 100 is inserted into the mating connector 200, the first extension protrusion 141 is inserted into the first accommodating sub-groove 851 under the guidance of the first guide inclined surface 1411, the second extension protrusion 142 is inserted into the second accommodating sub-groove 852 under the guidance of the second guide inclined surface 1421, the third extension protrusion 151 is inserted into the third accommodating sub-groove 861 under the guidance of the third guide inclined surface 1511, and the fourth extension protrusion 152 is inserted into the fourth accommodating sub-groove 862 under the guidance of the fourth guide inclined surface 1521. The first locking protrusion 8331 enters the first recessed groove 1412 and crosses the first recessed groove 1412 under the guidance of the first inclined surface 1414a to be locked into the first retaining groove 1413. The second locking protrusion 8332 enters the second recessed groove 1422 and crosses the second recessed groove 1422 under the guidance of the second inclined surface 1424a to be locked in the second retaining groove 1423. The third locking protrusion 8341 enters the third recessed groove 1512 and crosses the third recessed groove 1512 under the guidance of the third inclined surface 1514a to be locked in the third retaining groove 1513. The fourth locking protrusion 8342 enters the fourth recessed groove 1522 and crosses the fourth recessed groove 1522 under the guidance of the fourth inclined surface 1524a to be locked in the fourth retaining groove 1523. Finally, the first electrical connector 100 and the mating connector 200 realize locking on both the left and right sides.

It is understandable to those skilled in the art that when the first electrical connector 100 is inserted into the mating connector 200 and inserted in place, the first protrusion 814 and the second protrusion 815 of the mating connector 200 are clamped in the first slot 143 and the second slot 153 of the first electrical connector 100, respectively. With the height of the first protrusion 814 and the second protrusion 815 in the mating direction B, the first protrusion 814 and the second protrusion 815 can prevent the first electrical connector 100 from tilting due to an external force, thereby improving the mating reliability. It is understandable to those skilled in the art that in the second embodiment of the present disclosure, the first protrusion 814 and the second protrusion 815 are integrally formed with the first connecting wall portion 8123 and the third connecting wall portion 8123, respectively. Of course, in other embodiments, the first protrusion 814 and the second protrusion 815 may also be provided separately from the mating insulating body 81, and fixed to the mating insulating body 81 and/or the metal shell 83, which will not be described again in the present disclosure.

In the present disclosure, by providing the first locking protrusion 301 and the second locking protrusion 302 on the two sides, the two-side locking in the front-rear direction/the second direction can be achieved, thereby improving the mating reliability and reducing the risk of the first electrical connector 100 and the mating connector 200 becoming loose or tilted. In addition, by having the first locking protrusion 8331, the second locking protrusion 8332, the third locking protrusion 8341 and the fourth locking protrusion 8342 respectively locked in the first retaining groove 1413, the second retaining groove 1423, the third retaining groove 1513 and the fourth retaining groove 1523, the two-side locking in the left and right direction/the first direction can be realized, which further improves the mating reliability and further reduces the risk of the first electrical connector 100 and the mating connector 200 becoming loose or tilted.

When the first electrical connector 100 and the mating connector 200 need to be unlocked, an external force is applied to pull the first pull strap 7, and the first pull strap 7 generates a component force along the moving direction C, and the component force in this direction overcomes the force of the first elastic component 4, so that the first movable component 3 moves along the moving direction C. The first ejector rod 32 and the second ejector rod 33 move away from the insertion plate portion 8321 backwards, so that the second locking protrusion 302 and the second locking hole 8322 are disengaged from each other. The first locking protrusion 301 and the first locking hole 8311 are also separated from each other.

Besides, during the unlocking process, the first locking protrusion 8331, the second locking protrusion 8332, the third locking protrusion 8341 and the fourth locking protrusion 8342 respectively cross the first partition wall 1414, the second partition wall 1424, the third partition wall 1514 and the fourth partition wall 1524, under the guidance of the first extraction guide portion 8331b, the second extraction guide portion 8332b, the third extraction guide portion 8341b and the fourth extraction guide portion 8342b, so as to achieve unlocking.

In other words, at this time, the first electrical connector 100 and the mating connector 200 complete the unlocking on both sides of the left-right direction/the first direction and the unlocking on both sides of the front-rear direction/the second direction. The first electrical connector 100 can be pulled out of the mating connector 200 by applying another force or by exerting an upward force component on the first pull strap 7.

Referring to FIG. 39 to FIG. 41, the second electrical connector 100′ includes a second insulating body 1′, a plurality of second conductive terminals 2′ fixed to the second insulating body 1′, a second movable component 3′ installed on the second insulating body 1′, a second elastic component (not shown) for abutting against the second movable component 3, a second cable 5′ electrically connected to the second conductive terminal 2′, a second cover plate 6′ fastened to the second insulating body 1′ and at least partially abutting against the second cable 5′, and a second pull strap 7′ connected to the second movable component 3′.

The second insulating body 1′ includes a second main body 11′, a second tongue plate 12′ protruding downwardly beyond the second main body 11′ along the mating direction B, and a second positioning plate 13′ further protruding downwardly beyond the second tongue plate 12′ along the mating direction B. Each second conductive terminal 2′ includes a second mating portion 21′ provided on inner and outer surfaces of the second tongue plate 12′. In the illustrated embodiment of the present disclosure, a dimension of the second main body 11′ along a front-rear direction/a second direction, a dimension of the second tongue plate 12′ along the front-rear direction, and the dimension of the second positioning plate 13′ along the front-rear direction become smaller in sequence, so that the second insulating body 1′ is roughly of a stepped configuration. In the illustrated embodiment of the present disclosure, the second positioning plate 13′ includes a fourth positioning piece 131′ located in a middle, a fifth positioning piece 132′ located on one side of the fourth positioning piece 131′ and spaced apart from the fourth positioning piece 131′, and a sixth positioning piece 133′ located on another side of the fourth positioning piece 131′ and spaced apart from the fourth positioning piece 131′. A dimension of the fourth positioning piece 131′ along a left-right direction/a first direction is larger than a dimension of the fifth positioning piece 132′ along the left-right direction. The dimension of the fourth positioning piece 131′ along the left-right direction is also larger than a dimension of the sixth positioning piece 133′ along the left-right direction. In the illustrated embodiment of the present disclosure, a distance between the fourth positioning piece 131′ and the fifth positioning piece 132′ is different from a distance between the fourth positioning piece 131′ and the sixth positioning piece 133′. This arrangement can play a certain anti-fooling role, so that the second electrical connector 100′ can be inserted into the another mating connector 200′ at a certain angle.

It is understandable to those skilled in the art that the second electrical connector 100′ in the electrical connector assembly of the first embodiment of the present disclosure is substantially the same as the first electrical connector 100. For the same or corresponding structures, reference can be made to the description of the first electrical connector 100, which will not be described again in the present disclosure.

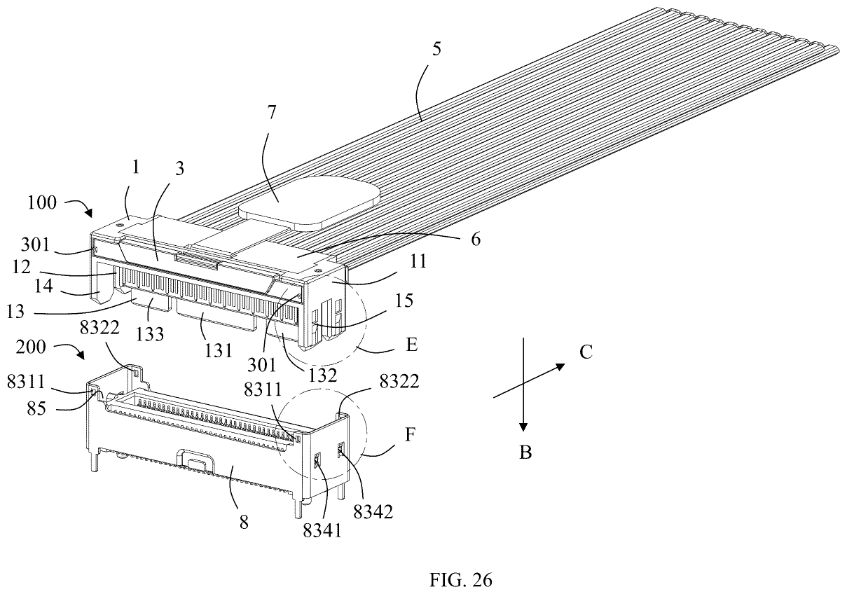

Referring to FIG. 26 and FIG. 39, it is understandable to those skilled in the art that when the mating connector 200 is installed on the first circuit board 300 in the first position and is mated with the first electrical connector 100, and when the another mating connector 200′ is installed on the second circuit board 300′ in the second position and is mated with the second electrical connector 100′, an outlet direction of the first cable 5 of the first electrical connector 100 is the same as an outlet direction of the second cable 5′ of the second electrical connector 100′. For example, the outlet direction of the first cable 5 and the outlet direction of the second cable 5′ both extend along the moving direction C. With this arrangement, the first cable 5 and the second cable 5′ can be arranged together, avoiding the cable from being folded back and reducing the mating height, which is beneficial to reducing the overall height of the electrical connector assembly.

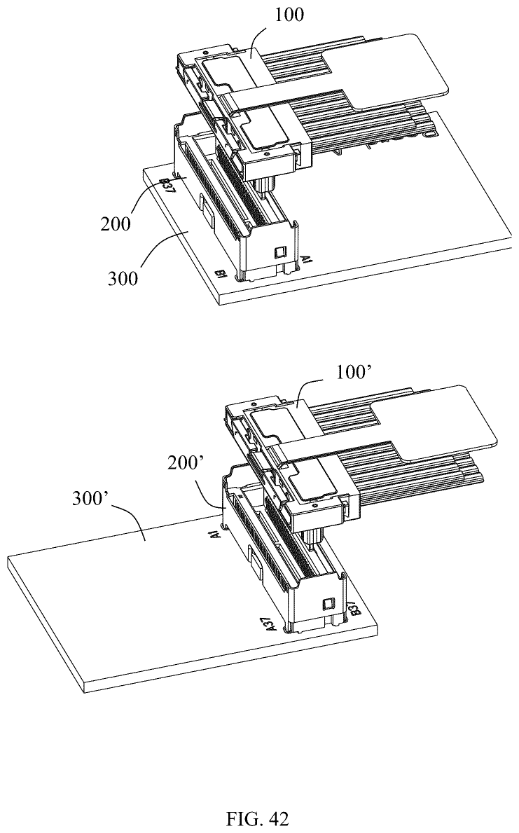

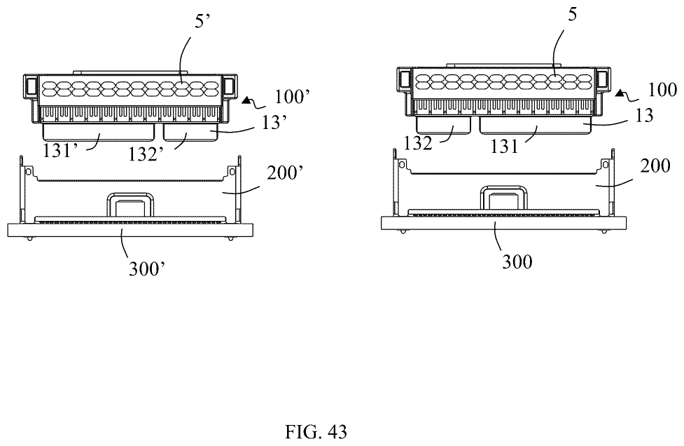

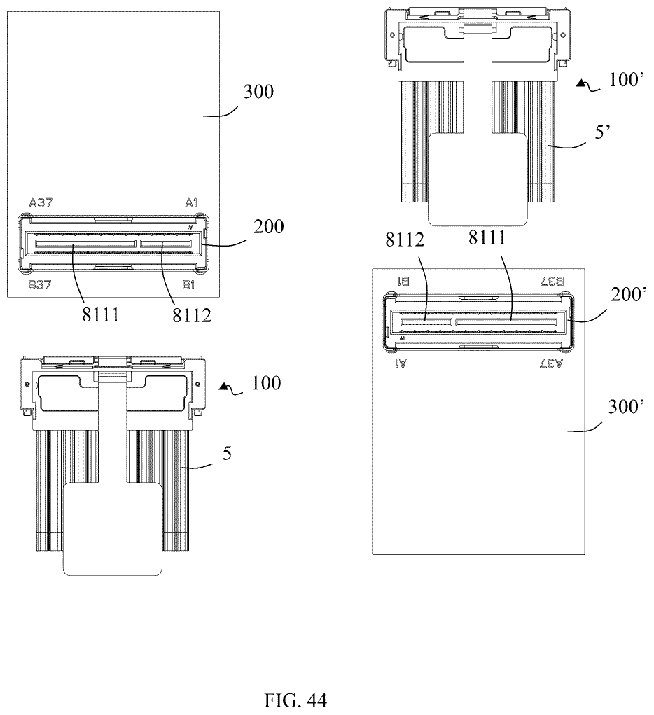

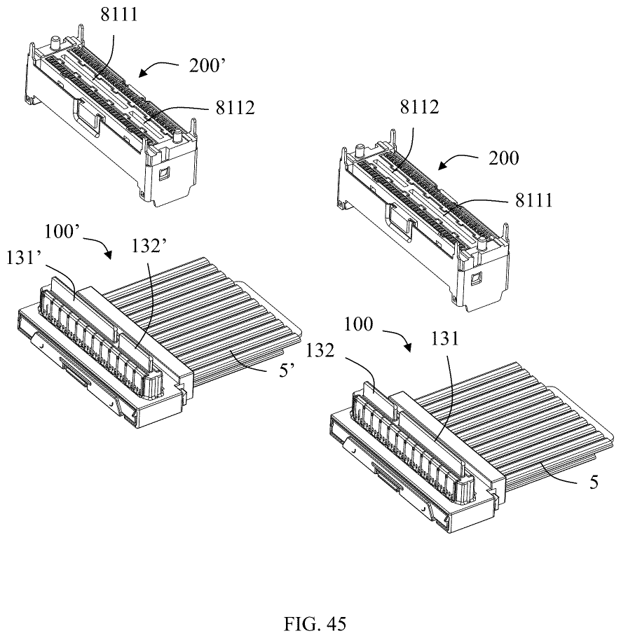

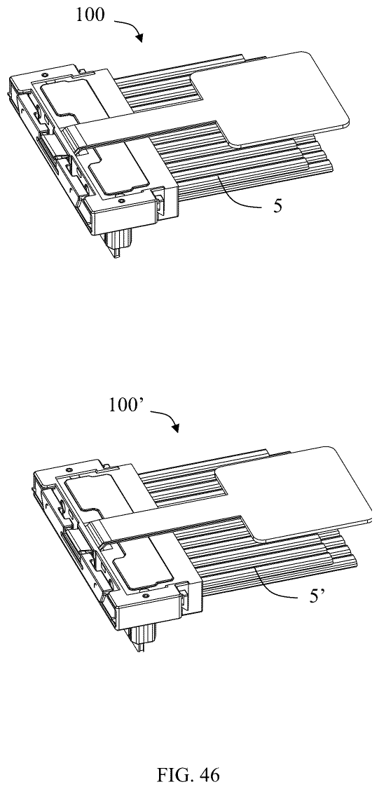

Referring to FIG. 42 to FIG. 46, in a third embodiment of the present disclosure, the first electrical connector 100 is similar to the first electrical connector 100 in the second embodiment, the second electrical connector 100′ is similar to the second electrical connector 100′ in the second embodiment, the mating connector 200 is similar to the mating connector 200 in the second embodiment, the another mating connector 200′ is similar to the another mating connector 200′ in the second embodiment. In the second embodiment and the third embodiment of the present disclosure, the same numbers indicate the same or corresponding technical features.

The main difference between the mating connector 200 in the third embodiment of the present disclosure and the mating connector 200 in the second embodiment of the present disclosure is that, in the third embodiment of the present disclosure, the positioning groove 8110 includes a first positioning groove 8111 and a second positioning groove 8112. The first positioning groove 8111 and the second positioning groove 8112 extend through the bottom wall 811. The first positioning groove 8111 and the second positioning groove 8112 have different widths.

The main difference between the first electrical connector 100 in the third embodiment of the present disclosure and the first electrical connector 100 in the second embodiment of the present disclosure is that the first positioning plate 13 includes a first positioning piece 131 and a second positioning piece 132 which is located on one side of the first positioning piece 131 and is spaced apart from the first positioning piece 131. The dimension of the first positioning piece 131 along the left-right direction/the first direction is larger than the dimension of the second positioning piece 132 along the left-right direction. The first positioning piece 131 and the second positioning piece 132 are configured to be inserted into and positioned in the first positioning groove 8111 and the second positioning groove 8112, respectively. This arrangement can play a certain anti-fooling role and prevent the first electrical connector 100 from being inserted into the mating connector 200 at a wrong angle.

Similarly, the main difference between the second electrical connector 100′ in the third embodiment of the present disclosure and the second electrical connector 100′ in the second embodiment of the present disclosure is that the second positioning plate 13′ includes a fourth positioning piece 131′ and a fifth positioning piece 132′ which is located on one side of the fourth positioning piece 131′ and is spaced apart from the fourth positioning piece 131′. The dimension of the fourth positioning piece 131′ along the left-right direction/the first direction is larger than the dimension of the fifth positioning piece 132′ along the left-right direction. The fourth positioning piece 131′ and the fifth positioning piece 132′ are configured to be inserted and positioned in the first positioning groove 8111 and the second positioning groove 8112, respectively. This arrangement can play a certain anti-fooling role and prevent the second electrical connector 100′ from being inserted into the another mating connector 200′ at a wrong angle.

Referring to FIG. 42 to FIG. 46, it is understandable to those skilled in the art that when the mating connector 200 is installed on the first circuit board 300 in the first position and is mated with the first electrical connector 100, and when the another mating connector 200′ is installed on the second circuit board 300′ in the second position and is mated with the second electrical connector 100′, the outlet direction of the first cable 5 of the first electrical connector 100 is the same as the outlet direction of the second cable 5′ of the second electrical connector 100′. With this arrangement, the first cable 5 and the second cable 5′ can be arranged together, avoiding the cable from being folded back and reducing the mating height, which is beneficial to reducing the overall height of the electrical connector assembly.

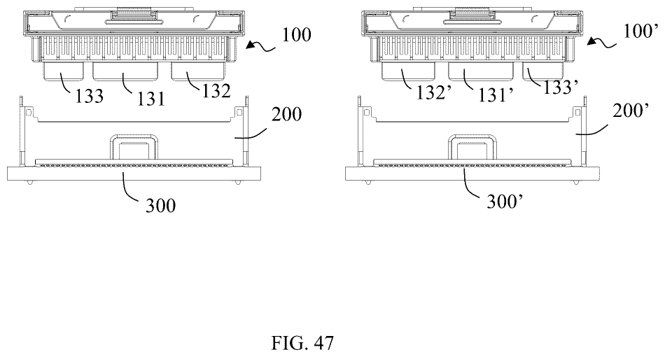

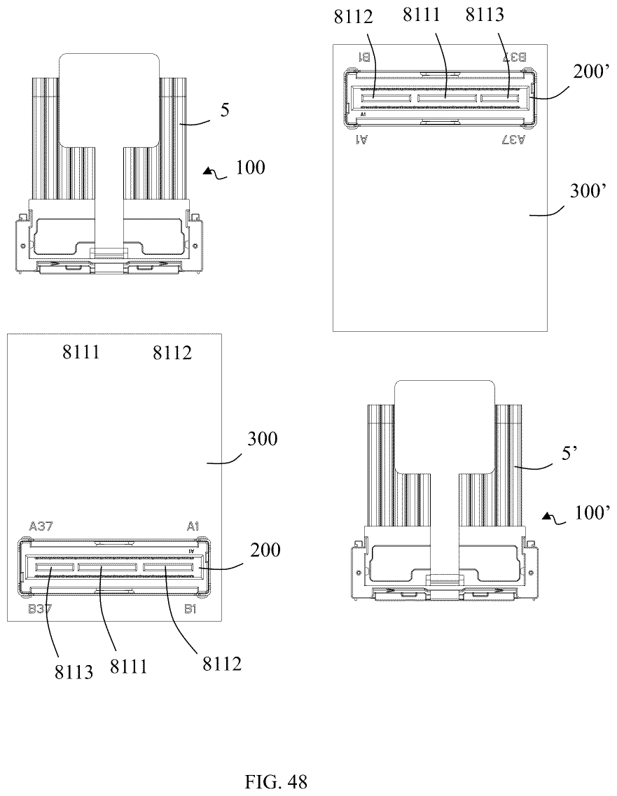

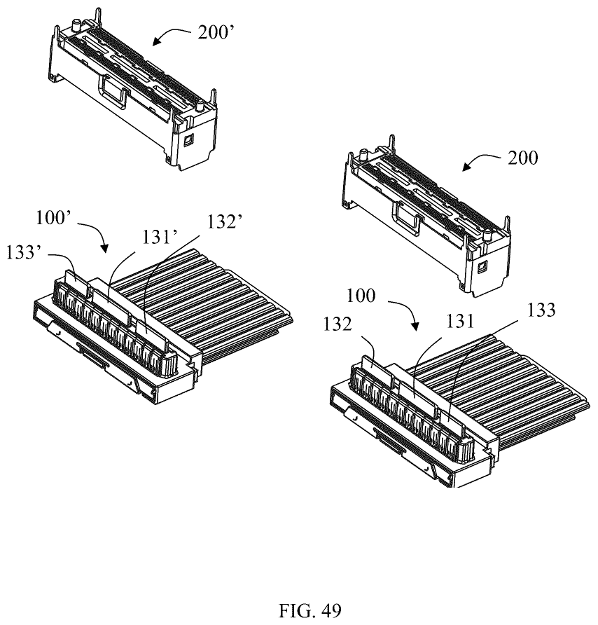

Referring to FIG. 47 to FIG. 49, in a fourth embodiment of the present disclosure, the first electrical connector 100 is similar to the first electrical connector 100 in the second embodiment, the second electrical connector 100′ is similar to the second electrical connector 100′ in the second embodiment, the mating connector 200 is similar to the mating connector 200 in the second embodiment, the another mating connector 200′ is similar to the another mating connector 200′ in the second embodiment. In the second embodiment and the third embodiment of the present disclosure, the same numbers indicate the same or corresponding technical features.

The main difference between the first electrical connector 100 in the fourth embodiment of the present disclosure and the first electrical connector 100 in the second embodiment of the present disclosure is that the first electrical connector 100 in the fourth embodiment is not provided with the first extension portion 14 and the second extension portion 15.

The main difference between the second electrical connector 100′ in the fourth embodiment of the present disclosure and the second electrical connector 100′ in the second embodiment of the present disclosure is that the second electrical connector 100′ in the fourth embodiment is not provided with the first extension portion 14 and the second extension portion 15.

Referring to FIG. 47 to FIG. 49, it is understandable to those skilled in the art that when the mating connector 200 is installed on the first circuit board 300 in the first position and is mated with the first electrical connector 100, and when the another mating connector 200′ is installed on the second circuit board 300′ in the second position and is mated with the second electrical connector 100′, the outlet direction of the first cable 5 of the first electrical connector 100 is the same as the outlet direction of the second cable 5′ of the second electrical connector 100′. With this arrangement, the first cable 5 and the second cable 5′ can be arranged together, avoiding the cable from being folded back and reducing the mating height, which is beneficial to reducing the overall height of the electrical connector assembly.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A mating connector, comprising:
a mating insulating body, the mating insulating body comprising a bottom wall, a plurality of wall portions and a mating slot at least partially formed by the plurality of wall portions; the bottom wall defining a positioning groove in communication with the mating slot; the plurality of wall portions comprising a first wall portion and a second wall portion which is disposed opposite to the first wall portion; the mating slot being located between the first wall portion and the second wall portion; and
a plurality of mating terminals, the plurality of mating terminals being provided on the mating insulating body, each mating terminal comprising an elastic mating arm extending into the mating slot;
wherein the mating connector is configured to be installed on a first circuit board in a first position to mate with a first electrical connector; the first electrical connector comprises a first tongue plate, a plurality of first mating portions provided on the first tongue plate, a first positioning plate protruding beyond the first tongue plate, and a first cable; the mating slot and the positioning groove are configured to receive the first tongue plate and the first positioning plate of the first electrical connector, respectively; the first mating portion is in contact with the elastic mating arm;
the mating connector is also configured to be mounted on a second circuit board in a second position to mate with a second electrical connector; the second electrical connector comprises a second tongue plate, a plurality of second mating portions provided on the second tongue plate, a second positioning portion protruding beyond the second tongue plate, and a second cable; the mating slot and the positioning groove are configured to receive the second tongue plate and the second positioning plate of the second electrical connector, respectively; the second mating portion is in contact with the elastic mating arm;
the first circuit board and the second circuit board are the same or different circuit boards;
the first electrical connector and the second electrical connector are the same or different electrical connectors;
the mating connector in the second position is formed by rotating the mating connector in the first position by 180 degrees in a plane where the first circuit board is located;
neither the first cable nor the second cable is folded, and outlet directions of the first cable and the second cable are the same.

2. The mating connector according to claim 1, wherein the plurality of wall portions comprise a first connecting wall portion connecting one side of the first wall portion and one side of the second wall portion, and a second connecting wall portion connecting another side of the first wall portion and another side of the second wall portion;
the mating connector further comprises a metal shell at least partially covering the mating insulating body; the metal shell comprising a first side wall, a second side wall disposed opposite to the first side wall, a first connecting wall connecting one side of the first side wall and one side of the second side wall, and a second connecting wall connecting another side of the first side wall and another side of the second side wall;
wherein the mating connector comprises a first accommodating groove located between the first connecting wall portion and the first connecting wall, and a second accommodating groove located between the second connecting wall portion and the second connecting wall;
the mating connector comprises a first protrusion located in the first accommodating groove; the first protrusion divides the first accommodating groove into a first accommodating sub-groove and a second accommodating sub-groove;
the mating connector comprises a second protrusion located in the second accommodating groove; the second protrusion divides the second accommodating groove into a third accommodating sub-groove and a fourth accommodating sub-groove;
the first accommodating sub-groove, the second accommodating sub-groove, the third accommodating sub-groove and the fourth accommodating sub-groove are configured to at least partially receive the first electrical connector.

3. The mating connector according to claim 2, wherein the first protrusion and the second protrusion are both provided on the mating insulating body; the first protrusion integrally extends from the first connecting wall portion away from the second connecting wall portion; and the second protrusion integrally extends from the second connecting wall portion away from the first connecting wall portion.

4. The mating connector according to claim 2, wherein the first connecting wall is provided with a first locking protrusion protruding inwardly into the first accommodating sub-groove, and a second locking protrusion protruding inwardly into the second accommodating sub-groove;
the second connecting wall is provided with a third locking protrusion protruding inwardly into the third accommodating sub-groove, and a fourth locking protrusion protruding inwardly into the fourth accommodating sub-groove;
the first locking protrusion, the second locking protrusion, the third locking protrusion and the fourth locking protrusion are configured to lock with the first electrical connector.

5. The mating connector according to claim 4, wherein the first locking protrusion and the second locking protrusion are both simply supported beams; the first locking protrusion is provided with a first insertion guide portion and a first extraction guide portion located at two ends thereof; the second locking protrusion is provided with a second insertion guide portion and a second extraction guide portion located at two ends thereof;
the third locking protrusion and the fourth locking protrusion are both simply supported beams; the third locking protrusion is provided with a third insertion guide portion and a third extraction guide portion located at two ends thereof; the fourth locking protrusion is provided with a fourth insertion guide portion and a fourth extraction guide portion located at two ends thereof.

6. The mating connector according to claim 1, wherein the positioning groove comprises a first positioning groove and a second positioning groove spaced apart from the first positioning groove; the first positioning groove and the second positioning groove have different widths;
the first positioning plate comprises a first positioning piece and a second positioning piece spaced apart from the first positioning piece; the first positioning piece and the second positioning piece have different widths;
the first positioning piece is configured to be inserted into and positioned in the first positioning groove; and the second positioning piece is configured to be inserted into and positioned in the second positioning groove.

7. The mating connector according to claim 6, wherein the positioning groove comprises a third positioning groove spaced apart from the first positioning groove; the second positioning groove and the third positioning groove are located on two sides of the first positioning groove, respectively; the first positioning groove, the second positioning groove and the third positioning groove all have different widths;
the first positioning plate comprises a third positioning piece spaced apart from the first positioning piece; the second positioning piece and the third positioning piece are located on two sides of the first positioning piece, respectively; the first positioning piece, the second positioning piece and the third positioning piece all have different widths;
the third positioning piece is configured to be inserted into and positioned in the third positioning groove.

8. The mating connector according to claim 6, wherein the positioning groove comprises a third positioning groove spaced apart from the first positioning groove; the second positioning groove and the third positioning groove are located on two sides of the first positioning groove, respectively; a distance between the first positioning groove and the second positioning groove is different from a distance between the first positioning groove and the third positioning groove;
the first positioning plate comprises a third positioning piece spaced apart from the first positioning piece; the second positioning piece and the third positioning piece are located on two sides of the first positioning piece, respectively; a distance between the first positioning piece and the second positioning piece is different from a distance between the first positioning piece and the third positioning piece;
the third positioning piece is configured to be inserted into and positioned in the third positioning groove.

9. An electrical connector assembly, comprising:
a mating connector, the mating connector comprising:
a mating insulating body, the mating insulating body comprising a bottom wall, a plurality of wall portions and a mating slot at least partially formed by the plurality of wall portions; the bottom wall defining a positioning groove in communication with the mating slot; the plurality of wall portions comprising a first wall portion and a second wall portion opposite to the first wall portion; the mating slot being located between the first wall portion and the second wall portion; and
a plurality of mating terminals, the plurality of mating terminals being provided on the mating insulating body; each mating terminal comprising an elastic mating arm extending into the mating slot;
a first electrical connector, the first electrical connector comprising a first tongue plate, a plurality of first mating portions provided on the first tongue plate, a first positioning plate protruding beyond the first tongue plate, and a first cable;
another mating connector, the another mating connector having a same structure as the mating connector, but having a different installation angle; and
a second electrical connector, the second electrical connector comprising a second tongue plate, a plurality of second mating portions provided on the second tongue plate, a second positioning portion protruding beyond the second tongue plate, and a second cable;
wherein the mating connector is configured to be installed on a first circuit board in a first position to mate with the first electrical connector; the mating slot and the positioning groove of the mating connector receive the first tongue plate and the first positioning plate of the first electrical connector, respectively; the first mating portion is in contact with the elastic mating arm of the mating connector;
the another mating connector is configured to be mounted on a second circuit board in a second position to mate with the second electrical connector; the mating slot and the positioning groove of the another mating connector receive the second tongue plate and the second positioning slot of the second electrical connector, respectively; the second mating portion is in contact with the elastic mating arm of the another mating connector;
the first circuit board and the second circuit board are the same or different circuit boards;
the first electrical connector and the second electrical connector are the same or different electrical connectors;
the another mating connector in the second position is formed by rotating the mating connector in the first position by 180 degrees in a plane where the first circuit board is located;
neither the first cable nor the second cable is folded; and outlet directions of the first cable and the second cable are the same.

10. The electrical connector assembly according to claim 9, wherein the plurality of wall portions comprise a first connecting wall portion connecting one side of the first wall portion and one side of the second wall portion, and a second connecting wall portion connecting another side of the first wall portion and another side of the second wall portion;
the mating connector further comprises a metal shell at least partially covering the mating insulating body; the metal shell comprising a first side wall, a second side wall disposed opposite to the first side wall, a first connecting wall connecting one side of the first side wall and one side of the second side wall, and a second connecting wall connecting another side of the first side wall and another side of the second side wall;
wherein the mating connector comprises a first accommodating groove located between the first connecting wall portion and the first connecting wall, and a second accommodating groove located between the second connecting wall portion and the second connecting wall;
the mating connector comprises a first protrusion located in the first accommodating groove; the first protrusion divides the first accommodating groove into a first accommodating sub-groove and a second accommodating sub-groove;
the mating connector comprises a second protrusion located in the second accommodating groove; the second protrusion divides the second accommodating groove into a third accommodating sub-groove and a fourth accommodating sub-groove;
the first accommodating sub-groove, the second accommodating sub-groove, the third accommodating sub-groove and the fourth accommodating sub-groove are configured to at least partially receive the first electrical connector.

11. The electrical connector assembly according to claim 10, wherein the first protrusion and the second protrusion are both provided on the mating insulating body; the first protrusion integrally extends from the first connecting wall portion away from the second connecting wall portion; and the second protrusion integrally extends from the second connecting wall portion away from the first connecting wall portion.

12. The electrical connector assembly according to claim 10, wherein the first connecting wall is provided with a first locking protrusion protruding inwardly into the first accommodating sub-groove, and a second locking protrusion protruding inwardly into the second accommodating sub-groove;
the second connecting wall is provided with a third locking protrusion protruding inwardly into the third accommodating sub-groove, and a fourth locking protrusion protruding inwardly into the fourth accommodating sub-groove;
the first locking protrusion, the second locking protrusion, the third locking protrusion and the fourth locking protrusion are configured to lock with the first electrical connector.

13. The electrical connector assembly according to claim 12, wherein the first locking protrusion and the second locking protrusion are both simply supported beams; the first locking protrusion is provided with a first insertion guide portion and a first extraction guide portion located at two ends thereof; the second locking protrusion is provided with a second insertion guide portion and a second extraction guide portion located at two ends thereof;
the third locking protrusion and the fourth locking protrusion are both simply supported beams; the third locking protrusion is provided with a third insertion guide portion and a third extraction guide portion located at two ends thereof; the fourth locking protrusion is provided with a fourth insertion guide portion and a fourth extraction guide portion located at two ends thereof.

14. The electrical connector assembly according to claim 9, wherein the positioning groove comprises a first positioning groove and a second positioning groove spaced apart from the first positioning groove; the first positioning groove and the second positioning groove have different widths;
the first positioning plate comprises a first positioning piece and a second positioning piece spaced apart from the first positioning piece; the first positioning piece and the second positioning piece have different widths;
the first positioning piece is configured to be inserted into and positioned in the first positioning groove; and the second positioning piece is configured to be inserted into and positioned in the second positioning groove.

15. The electrical connector assembly according to claim 14, wherein the positioning groove comprises a third positioning groove spaced apart from the first positioning groove; the second positioning groove and the third positioning groove are located on two sides of the first positioning groove, respectively; the first positioning groove, the second positioning groove and the third positioning groove all have different widths;
the first positioning plate comprises a third positioning piece spaced apart from the first positioning piece; the second positioning piece and the third positioning piece are located on two sides of the first positioning piece, respectively; the first positioning piece, the second positioning piece and the third positioning piece all have different widths;
the third positioning piece is configured to be inserted into and positioned in the third positioning groove.

16. The electrical connector assembly according to claim 14, wherein the positioning groove comprises a third positioning groove spaced apart from the first positioning groove; the second positioning groove and the third positioning groove are located on two sides of the first positioning groove, respectively; a distance between the first positioning groove and the second positioning groove is different from a distance between the first positioning groove and the third positioning groove;
the first positioning plate comprises a third positioning piece spaced apart from the first positioning piece; the second positioning piece and the third positioning piece are located on two sides of the first positioning piece, respectively; a distance between the first positioning piece and the second positioning piece is different from a distance between the first positioning piece and the third positioning piece;
the third positioning piece is configured to be inserted into and positioned in the third positioning groove.
